(19) United States
(12) Patent Application Publication
(10) Pub. No.: US 2026/0074767 A1
(43) Pub. Date: Mar. 12, 2026

(54) METHOD AND APPARATUS FOR DETERMINING PMI IN WIRELESS COMMUNICATION SYSTEM

(71) Applicant: Samsung Electronics Co., Ltd., Suwon-si (KR)

(72) Inventors: Dongjae LEE, Suwon-si (KR); Jonghwan KIM, Suwon-si (KR)

(21) Appl. No.: 19/394,132

(22) Filed: Nov. 19, 2025

Related U.S. Application Data
(63) Continuation of application No. PCT/KR2024/006346, filed on May 10, 2024.

(30) Foreign Application Priority Data
May 19, 2023 (KR) 10-2023-0065207
Jun. 15, 2023 (KR) 10-2023-0076731

(51) Int. Cl. H04B 7/06; H04B 7/0413

(52) U.S. Cl. CPC H04B 7/0639; H04B 7/0413; H04B 7/0626; H04B 7/06952

(57) ABSTRACT

A method performed by a receiving end in a wireless communication system is provided. The method includes receiving one or more reference signals (RSs) from a transmitting end, identifying, based on channel frequency response (CFR) identified based on the received one or more RSs, one or more matrixes associated with a plurality of antennas, which are included in the receiving end or the transmitting end and are for transmitting downlink data, converting the identified one or more matrixes into values associated with angles of beams formed by the plurality of antennas, determining, based on the values associated with the angles of the beams, one or more precoding matrix indicators (PMIs), which can be applied to the plurality of antennas, and identifying a first PMI corresponding to a maximum downlink data throughput from among the one or more PMIs.

### CROSS-REFERENCE TO RELATED APPLICATION(S)

This application is a continuation application, claiming priority under 35 U.S.C. § 365(c), of an International application No. PCT/KR2024/006346, filed on May 10, 2024, which is based on and claims the benefit of a Korean patent application number 10-2023-0065207, filed on May 19, 2023, in the Korean Intellectual Property Office, and of a Korean patent application number 10-2023-0076731, filed on Jun. 15, 2023, in the Korean Intellectual Property Office, the disclosure of each of which is incorporated by reference herein in its entirety.

### BACKGROUND

### 1. Field

The disclosure relates to a wireless communication system (or a mobile communication system). More particularly, the disclosure relates to a method and an apparatus for determining a precoding matrix indicator (PMI) in a wireless communication system.

### 2. Description of Related Art

5^{th} generation (5G) mobile communication technologies define broad frequency bands such that high transmission rates and new services are possible, and can be implemented not only in “Sub 6 GHz” bands, such as 3.5 GHz, but also in “Above 6 GHz” bands referred to as millimeter wave (mmWave) including 28 GHz and 39 GHz. In addition, it has been considered to implement 6th generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input and multiple output (MIMO) for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

A receiving node determines a precoding matrix indicator (PMI), based on a received reference signal (RS), and transmits the determined PMI to a transmitting node. For example, the receiving node identifies an optimal PMI among the multiple PMIs that increases a throughput in communication between the transmitting node and the receiving node, and transmits information on the identified optimal PMI to the transmitting node.

Meanwhile, in order to determine the optimal PMI, the receiving node needs to calculate data throughputs corresponding to respective multiple PMIs. When the receiving node calculates the data throughput for all the multiple PMIs, unnecessary computational resources and time is consumed.

In the disclosure, the receiving node, based on a channel frequency response (CFR), converts a matrix associated with a plurality of antennas for transmitting downlink data into values associated with angles of beams, and the receiving node determines an optimal PMI without calculating data throughput for all of multiple PMIs.

Aspects of the disclosure are to address at least the above-mentioned problems and/or disadvantages and to provide at least the advantages described below. Accordingly, an aspect of the disclosure is to provide a method and an apparatus for determining a PMI in a wireless communication system.

Additional aspects will be set forth in part in the description which follows and, in part, will be apparent from the description, or may be learned by practice of the presented embodiments.

In accordance with an aspect of the disclosure, a method performed by a receiving node in a wireless communication system is provided. The method includes receiving at least one reference signal (RS) from a transmitting node, identifying at least one matrix associated with a plurality of antennas, included in the receiving node or the transmitting node, for transmitting downlink data based on a channel frequency response (CFR), wherein the CFR is identified based on the received at least one RS, converting the identified at least one matrix into values associated with angles of beams formed by the plurality of antennas for transmitting the downlink data, determining at least one precoding matrix indicator (PMI) applicable to the plurality of antennas, based on the values associated with the angles of the beams, and identifying, from the at least one PMI, a first PMI corresponding to a maximum downlink data throughput, wherein each of the at least one PMI corresponds to at least one rank configured for multiple input and multiple output (MIMO).

In accordance with another aspect of the disclosure, a receiving node in a wireless communication system is provided. The receiving node includes memory, including one or more storage media, storing instructions, a transceiver, and at least one processor, including processing circuitry, communicatively coupled to the memory and the transceiver, wherein the instructions, when executed by the at least one processor individually or collectively, cause the receiving node to receive at least one reference signal (RS) from a transmitting node, identify at least one matrix associated with a plurality of antennas, included in the receiving node or the transmitting node, for transmitting downlink data, based on a channel frequency response (CFR), wherein the CFR is identified based on the at least one received at least one RS, convert the identified at least one matrix into values associated with angles of beams formed by the plurality of antennas for transmitting the downlink data, determine at least one precoding matrix indicator (PMI) applicable to the plurality of antennas, based on the values associated with the angles of the beams, and identify, from the at least one PMI, a first PMI corresponding to a maximum downlink data throughput, wherein each of the at least one PMI corresponds to at least one rank configured for multiple input and multiple output (MIMO).

In accordance with another aspect of the disclosure, one or more non-transitory computer-readable storage media storing one or more computer programs including computer-executable instruction that, when executed by one or more processors of a receiving node in a wireless communication system individually or collectively, cause the receiving node to perform operations are provided. The operations include receiving at least one reference signal (RS) from a transmitting node, identifying at least one matrix associated with a plurality of antennas, included in the receiving node or the transmitting node, for transmitting downlink data, based on a channel frequency response (CFR), wherein the CFR is identified based on the received at least one RS, converting the identified at least one matrix into values associated with angles of beams formed by the plurality of antennas for transmitting the downlink data, determining at least one precoding matrix indicator (PMI) applicable to the plurality of antennas, based on the values associated with the angles of the beams, and identifying, from the at least one PMI, a first PMI corresponding to a maximum downlink data throughput, wherein each of the at least one PMI corresponds to at least one rank configured for multiple-input and multiple-output (MIMO).

Computational resources and time consumed for calculating data throughput or a mutual information (MI) value corresponding to a PMI are minimized or reduced.

The receiving node identifies an optimal PMI having relatively higher accuracy than a PMI estimated based only on phase differences between entries obtained based on a principal component analysis (PCA) technique.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication system according to an embodiment of the disclosure;

FIG. 2 illustrates a structure of a user equipment (UE) according to an embodiment of the disclosure;

FIG. 3 illustrates a structure of a base station according to an embodiment of the disclosure;

FIG. 4A illustrates a method in which at least one signal is transmitted and/or received by a receiving node or a transmitting node in a wireless communication system according to an embodiment of the disclosure;

FIG. 4B illustrates a method in which a receiving node transmits an optimal precoding matrix indicator (PMI) to a transmitting node according to an embodiment of the disclosure;

FIG. 4C illustrates a method in which a receiving node transmits, based on a type of PMI report, information including different types of information elements (IEs) to a transmitting node according to an embodiment of the disclosure;

FIG. 5 illustrates a method in which a receiving node determines multiple PMIs according to an embodiment of the disclosure;

FIG. 6 illustrates a method in which a receiving node determines a first PMI according to an embodiment of the disclosure;

FIG. 7 illustrates a method for transmitting, to a transmitting node, information on a combination of a PMI and a modulation order corresponding to a highest mutual information (MI) value according to an embodiment of the disclosure;

FIG. 8 illustrates a method in which a receiving node identifies, based on received at least one reference signal (RS), a combination corresponding to a highest MI value among combinations of a PMI and a modulation order according to an embodiment of the disclosure;

FIG. 9 illustrates a method of identifying a combination corresponding to highest data throughput among combinations of a wideband PMI, a subband-specific PMI, and a modulation order according to an embodiment of the disclosure;

FIG. 10 is a diagram illustrating a comparison of data throughputs between a case in which at least one matrix is converted into values associated with angles of beams and a case in which phases between adjacent entries of an eigen matrix are used instead of performing a two-dimensional (2D) fast Fourier transform (FFT), according to an embodiment of the disclosure;

FIG. 11 is a diagram illustrating a comparison of data throughputs between a case in which at least one matrix is converted into values associated with angles of beams and a case in which phases between adjacent entries of an eigen matrix are used instead of performing 2D FFT, according to an embodiment of the disclosure;

FIG. 12 is a diagram illustrating a comparison of data throughputs between a case in which at least one matrix is converted into values associated with angles of beams and a case in which phases between adjacent entries of an eigen matrix are used instead of performing 2D FFT, according to an embodiment of the disclosure;

FIG. 13 is a diagram illustrating a comparison of data throughputs between a case in which at least one matrix is converted into values associated with angles of beams and a case in which phases between adjacent entries of an eigen matrix are used instead of performing 2D FFT, according to an embodiment of the disclosure;

FIG. 14 is a diagram illustrating a comparison of data throughputs between a case in which at least one matrix is converted into values associated with angles of beams and a case in which phases between adjacent entries of an eigen matrix are used instead of performing 2D FFT, according to an embodiment of the disclosure;

FIG. 15 is a diagram illustrating a comparison of data throughputs between a case in which at least one matrix is converted into values associated with angles of beams and a case in which phases between adjacent entries of an eigen matrix are used instead of performing 2D FFT, according to an embodiment of the disclosure;

FIG. 16 is a diagram illustrating a comparison of data throughputs between a case in which at least one matrix is converted into values associated with angles of beams and a case in which phases between adjacent entries of an eigen matrix are used instead of performing 2D FFT, according to an embodiment of the disclosure; and

FIG. 17 is a diagram illustrating a comparison of data throughputs between a case in which at least one matrix is converted into values associated with angles of beams and a case in which phases between adjacent entries of an eigen matrix are used instead of performing 2D FFT, according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

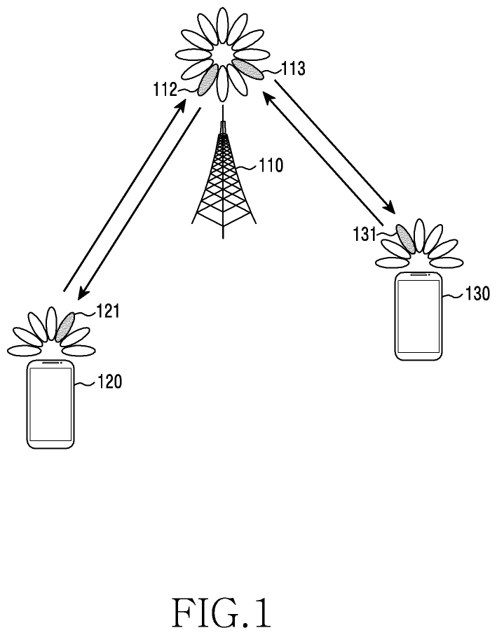

FIG. 1 illustrates a wireless communication system according to an embodiment of the disclosure.

Referring to FIG. 1, a base station 110, a first UE 120, and/or a second UE 130, as some of nodes using a radio channel in the wireless communication system, are illustrated. FIG. 1 illustrates only one base station, but this is merely an example. Other base stations identical or similar to the base station 110 may be further included in the wireless communication system of FIG. 1.

The base station 110 is a network infrastructure that provides the UEs 120 and 130 with radio access. The base station 110 has coverage defined as a certain geographical area, based on a distance over which a signal can be transmitted. In addition to the term “base station”, the base station 110 may be referred to as an “access point (AP)”, an “eNodeB (eNB)”, a “gNodeB (gNB)”, a “5^{th} generation node (5G node)”, a “wireless point”, a “transmission/reception point (TRP)”, or other terms having technical meanings equivalent thereto.

Each of the first UE 120 and the second UE 130 is a device used by a user, and may perform communication with the base station 110 via a radio channel. At least one of the UE 120 and the UE 130 may be operated without the user's involvement. For example, at least one of the first UE 120 and the second UE 130 may be a device which performs machine type communication (MTC), and may not be carried by the user. In addition to the term “terminal”, each of the first UE 120 and the second UE 130 may be referred to as a “user equipment (UE)”, a “mobile station”, a “subscriber station”, a “customer-premises equipment (CPE)”, a “remote terminal”, a “wireless terminal”, an “electronic device”, a “user device”, or other terms having technical meanings equivalent thereto.

The base station 110, the first UE 120, and the second UE 130 may transmit and/or receive wireless signals in millimeter wave (mmWave) bands (e.g., 28 GHz, 30 GHz, 38 GHz, and 60 GHz). In this case, in order to improve channel gain, the base station 110, the first UE 120, and the second UE 130 may perform beamforming.

The beamforming may include transmission beamforming and/or reception beamforming. For example, the base station 110, the first UE 120, and the second UE 130 may assign directivity to a transmission signal or a reception signal. To assign directivity to a transmission signal, the base station 110 and/or the UEs 120 and 130 may select serving beams 112, 113, 121, and 131 through a beam search or beam management procedure. After the serving beams 112, 113, 121, and 131 are selected, subsequent communication may be performed through a resource having a quasi co-located (QCL) relationship with a resource through which the serving beams 112, 113, 121, and 131 have been transmitted.

Each of the base station 110, the first UE 120, and the second UE 130 of the disclosure may be a transmitting apparatus, a transmitting node, a receiving node, a receiving apparatus, and/or a receiving node. For example, the base station 110 may transmit a radio frequency (RF) signal to the first UE 120. The base station 110 may receive an RF signal from the first UE 120. As another example, the first UE 120 may transmit an RF signal to the base station 110 or the second UE 130. The first UE 120 may receive an RF signal from the base station 110 or the second UE 130.

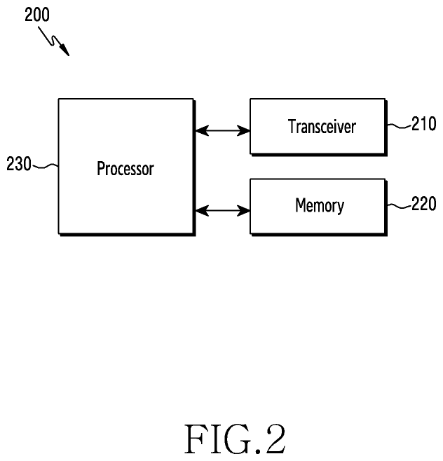

FIG. 2 illustrates a structure of a UE according to an embodiment of the disclosure.

Referring to FIG. 2, a UE 200 according to an embodiment of the disclosure may include a transceiver 210, memory 220, and/or a processor 230. Although the UE 200 is described herein as including the transceiver 210, the memory 220, and/or the processor 230, this is merely an example. For example, the UE 200 may further include components other than the transceiver 210, the memory 220, and the processor 230.

According to an embodiment of the disclosure, each of the transceiver 210, the memory 220, and the processor 230 may be implemented as a separate chip. However, this is merely an example, and the transceiver 210, the memory 220, and/or the processor 230 may be implemented as a single chip.

According to an embodiment of the disclosure, the transceiver 210 may include at least one transmitter and/or at least one receiver. For example, the transceiver 210 may include an RF transmitter for amplifying and up-converting the frequency of a transmitted signal. The transceiver 210 may include an RF receiver for down-converting and low-noise amplifying the frequency of a received signal.

The components of the transceiver 210 set forth herein are merely an example, and the components of the transceiver 210 are not limited to the RF transmitter and the RF receiver. For example, the transceiver 210 may further include a coupler for ensuring isolation between the RF transmitter and the RF receiver.

According to an embodiment of the disclosure, the transceiver 210 may transmit or receive a signal to or from the processor 230. For example, the transceiver 210 may transmit or deliver an RF signal, received via a radio channel, to the processor 230. The transceiver 210 may receive an RF signal from the processor 230 or the processor 230 may deliver an RF signal to the transceiver 210.

According to an embodiment of the disclosure, the transceiver 210 may be referred to as a “UE transmitter” or a “UE receiver”.

According to an embodiment of the disclosure, the transceiver 210 may transmit a signal to a base station (e.g., the base station 110 in FIG. 1) or a network entity (e.g., user plane function (UPF) entity) or receive a signal from the base station or the network entity. In an embodiment of the disclosure, the transmitted or received signal may include a control signal or data.

According to an embodiment of the disclosure, the memory 220 may store programs and data necessary for the operations of the UE 200. For example, the memory 220 may be non-transitory memory, and programs stored in the non-transitory memory may be organically coupled to hardware components (e.g., the processor 230 or the transceiver 210) of the UE 200. The memory 220 may store control information or data including a signal acquired by the UE 200. In an embodiment of the disclosure, the memory 220 may include read-only memory (ROM), random access memory (RAM), hard disk, compact disc-ROM (CD-ROM), digital versatile disc (DVD), or storage media.

According to an embodiment of the disclosure, the processor 230 may include one processor or multiple processors. For example, the processor 230 may include a communication processor. For example, the processor 230 may include a communication processor and/or an application processor.

According to an embodiment of the disclosure, the processor 230 may control a series of processes performed by the UE 200. For example, the transceiver 210 may receive a data signal including control information transmitted by the base station or the network entity. The processor 230 may process the received control signal and data signal.

The term “processor” in the disclosure may be replaced with various terms referring to components for executing or performing the operations of the UE 200. For example, the processor may be replaced with the term “controller” or “computing circuit”.

The UE 200 of the disclosure may correspond to the first UE 120 and/or the second UE 130 in FIG. 1.

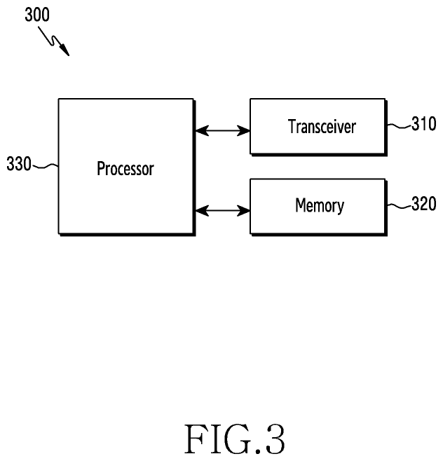

FIG. 3 illustrates a structure of a base station according to an embodiment of the disclosure.

Referring to FIG. 3, the base station 300 according to an embodiment of the disclosure may include a transceiver 310, memory 320, and/or a processor 330. Although the base station 300 is described herein as including the transceiver 310, the memory 320, and/or the processor 330, this is merely an example. For example, the base station 300 may further include components other than the transceiver 310, the memory 320, and the processor 330.

According to an embodiment of the disclosure, each of the transceiver 310, the memory 320, and the processor 330 may be implemented as a separate chip. However, this is merely an example, and the transceiver 310, the memory 320, and/or the processor 330 may be implemented as a single chip.

According to an embodiment of the disclosure, the transceiver 310 may include at least one transmitter and/or at least one receiver. For example, the transceiver 310 may include an RF transmitter for amplifying and up-converting the frequency of a transmitted signal. The transceiver 310 may include an RF receiver for down-converting and low-noise amplifying the frequency of a received signal.

The components of the transceiver 310 set forth herein are merely an example, and the components of the transceiver 310 are not limited to the RF transmitter and the RF receiver. For example, the transceiver 310 may further include a coupler for ensuring isolation between the RF transmitter and the RF receiver.

According to an embodiment of the disclosure, the transceiver 310 may transmit or receive a signal to or from the processor 330. For example, the transceiver 310 may transmit or deliver an RF signal, received via a radio channel, to the processor 330. The transceiver 310 may receive an RF signal from the processor 330 or the processor 330 may deliver an RF signal to the transceiver 310.

According to an embodiment of the disclosure, the transceiver 310 may be referred to as a “base station transmitter” or a “base station receiver”.

According to an embodiment of the disclosure, the transceiver 310 may transmit a signal to the UE 200 or receive a signal from the UE 200. In an embodiment of the disclosure, the transmitted or received signal may include a control signal or data.

According to an embodiment of the disclosure, the memory 320 may store programs and data necessary for the operations of the base station 300. For example, the memory 320 may be non-transitory memory, and programs stored in the non-transitory memory may be organically coupled to hardware components (e.g., the processor 330 or the transceiver 310) of the base station 300. The memory 320 may store control information or data including a signal acquired by the base station 300. In an embodiment of the disclosure, the memory 320 may include read-only memory (ROM), random access memory (RAM), hard disk, CD-ROM, DVD, storage media.

According to an embodiment of the disclosure, the processor 330 may include one processor or multiple processors. For example, the processor 330 may include a communication processor. For example, the processor 330 may include a communication processor and/or an application processor.

According to an embodiment of the disclosure, the processor 330 may control a series of processes performed by the base station 300. For example, the transceiver 310 may receive a data signal including control information transmitted by the base station or the network entity. The processor 330 may process the received control signal and data signal.

The term “processor” in the disclosure may be replaced with various terms referring to components for executing or performing the operations of the base station 300. For example, the processor may be replaced with the term “controller” or “computing circuit”.

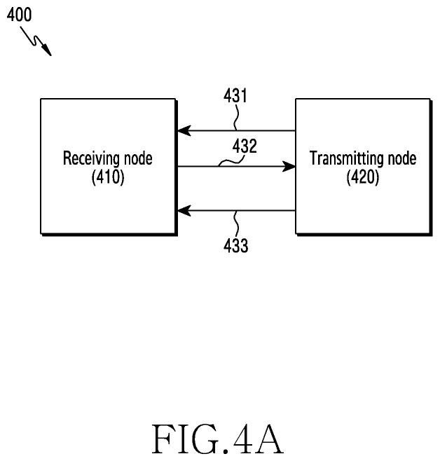

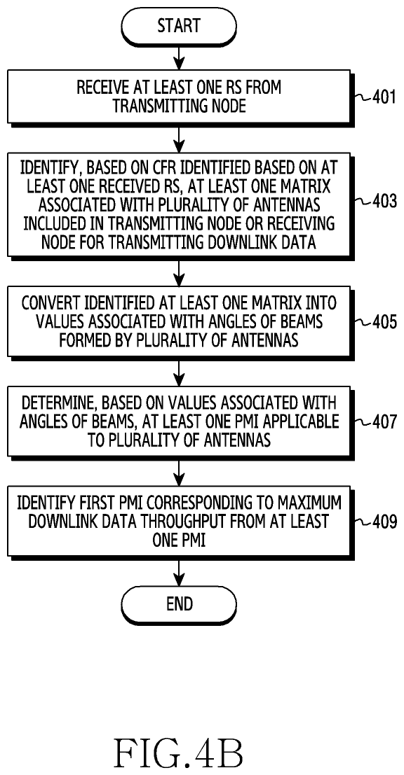

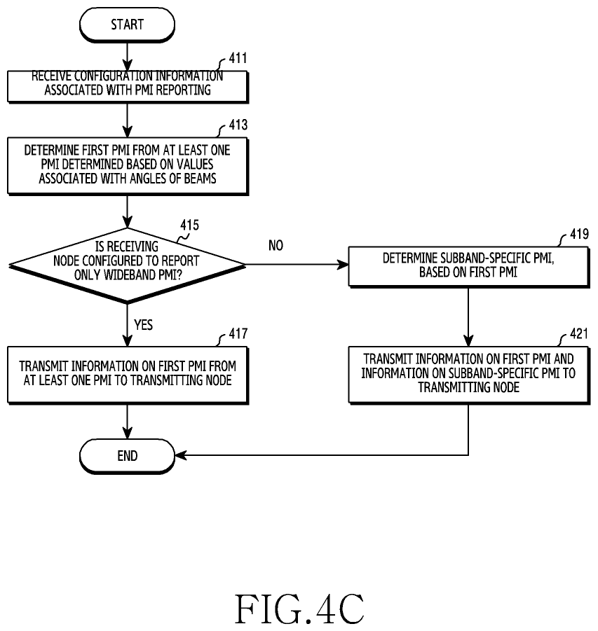

FIG. 4A illustrates a method in which at least one signal is transmitted and/or received by a receiving node or a transmitting node in a wireless communication system according to an embodiment of the disclosure.

Referring to FIG. 4A, a wireless communication system 400 according to an embodiment of the disclosure may include a receiving node 410 and a transmitting node 420. For example, the receiving node 410 may be a UE 200, and the transmitting node 420 may be a base station 300. For example, the receiving node 410 may be the base station 300, and the transmitting node 420 may be the UE 200.

For example, the receiving node 410 may be a sidelink relay or a remote user equipment (UE) that performs sidelink communication, and the transmitting node 420 may be a UE that performs sidelink communication.

According to an embodiment of the disclosure, the transmitting node 420 may transmit at least one signal to the receiving node 410 in operation 431. For example, the transmitting node 420 may transmit at least one reference signal (RS) to the receiving node 410, and the at least one RS may be a channel state information (CSI)-RS or a sounding reference signal (SRS).

For example, when the transmitting node 420 is the base station 300 and the receiving node 410 is the UE 200, the at least one RS may be a CSI-RS. For example, when the transmitting node 420 is the UE 200 and the receiving node 410 is the base station 300, the at least one RS may be an SRS.

According to an embodiment of the disclosure, the receiving node 410 (e.g., the UE) may, based on the received at least one RS, transmit information associated with an optimal PMI to the transmitting node 420 (e.g., the base station), in operation 432. For example, in a case in which the receiving node 410 is a UE, the UE may, based on the CSI-RS that has been received in operation 431, identify the optimal PMI, and may transmit information regarding the optimal PMI to the base station, in operation 432. As another example, when the receiving node 410 is a base station, the base station may, instead of performing operation 432, identify an optimal PMI for a downlink channel by using a reciprocity relationship between an uplink channel and a downlink channel, based on the SRS that has been received in operation 431.

For example, the optimal PMI may be referred to as a PMI that provides the highest data throughput in communication between the receiving node 410 and the transmitting node 420 among multiple PMIs. For example, the optimal PMI may be referred to as a PMI corresponding to a maximum mutual information (MI) value or a maximum data throughput among multiple PMIs.

However, in a case in which the receiving node 410 is a base station and the transmitting node 420 is a UE, the receiving node 410 (e.g., the base station) may omit the operation of transmitting the information associated with the optimal PMI to the transmitting node 420 (e.g., the UE). In other words, when the base station identifies the optimal PMI, the base station may directly apply the optimal PMI to the transmit antennas without separately transmitting information on the optimal PMI to the UE, and may transmit downlink data to the UE, based on the transmit antennas to which the optimal PMI is applied.

According to an embodiment of the disclosure, the information associated with the optimal PMI may be a response to at least one signal transmitted by the transmitting node 420. For example, the receiving node 410 (e.g., the UE) may transmit information associated with the optimal PMI in response to at least one RS transmitted by the transmitting node 420 (e.g., the base station).

According to an embodiment of the disclosure, the transmitting node 420 (e.g., a base station) may transmit data to the receiving node 410 (e.g., a UE), based on information associated with the optimal PMI, in operation 433. For example, the information associated with the optimal PMI may include information on the PMI corresponding to the highest data throughput and/or information on the modulation order corresponding to the highest data throughput. The transmitting node 420 may transmit data to the receiving node 410 on a user plane, based on the optimal PMI and the optimal modulation order.

However, when the transmitting node 420 is a UE and the receiving node 410 is a base station, the receiving node 410 (e.g., the base station), instead of the transmitting node 420 (e.g., the UE), may transmit downlink data to the transmitting node 420 (e.g., the UE). In other words, the base station may identify information on an optimal PMI and an optimal modulation order from the received SRS by using the reciprocity relationship between the uplink channel and the downlink channel, and may transmit downlink data, based on the identified optimal PMI and the optimal modulation order.

Hereinafter, methods in which the receiving node 410 determines an optimal PMI will be described with reference to FIGS. 4B, 4C, 5, 6, 7, 8, and 9.

In the disclosure, the receiving node 410 may be replaced by various terms meaning a device capable of receiving a signal from an external device. For example, the receiving node 410 may be replaced by a receiver, a receiving apparatus, or a receiving electronic device.

In the disclosure, the transmitting node 420 may be replaced by various terms meaning a device capable of transmitting a signal to an external device. For example, the transmitting node 420 may be replaced by a transmitter, a transmitting apparatus, or a transmitting electronic device.

In the disclosure, the receiving node 410 may not only receive at least one signal from an external device, but also transmit at least one signal to the external device. Similarly, the transmitting node 420 may transmit at least one signal to an external device, and may receive at least one signal from the external device.

The operations of the receiving node 410 described in FIGS. 4A, 4B, 4C, 5, 6, 7, 8, and 9 of the disclosure may be referred to as operations performed by a controller or at least one processor included in the receiving node 410. The operations of the transmitting node 420 described in FIGS. 4A, 4B, 4C, 5, 6, 7, 8, and 9 may be referred to as operations performed by a controller or at least one processor included in the transmitting node 420.

FIG. 4B illustrates a method in which a receiving node transmits an optimal PMI to a transmitting node according to an embodiment of the disclosure.

Referring to FIG. 4B, the receiving node 410 according to an embodiment of the disclosure may receive at least one RS from the transmitting node 420 in operation 401. For example, the transmitting node 420 (e.g., the base station 300) may generate at least one RS, and may transmit the at least one RS to the receiving node 410 (e.g., the UE 200) by allocating radio resources to the at least one RS through parameters of a radio resource control (RRC) layer. For example, at least one RS (e.g., CSI-RS) may be used to estimate a channel state of a downlink channel.

As another example, when a predetermined condition is satisfied, the transmitting node 420 (e.g., the UE 200) may transmit at least one RS to the receiving node 410 (e.g., the base station 300). In an example, at least one RS (e.g., SRS) may be used for channel state estimation of an uplink channel. In an example, the designated condition may include a case in which the transmitting node 420 (e.g., the UE 200) receives, from the receiving node 410 (e.g., the base station 300), a message requesting the transmitting node 420 (e.g., the UE 200) to transmit at least one RS. For example, the transmitting node 420 may transmit at least one RS in response to a request message for triggering RS transmission from the receiving node 410.

According to an embodiment of the disclosure, in operation 403, the receiving node 410 may, based on the received at least one RS, identify at least one matrix associated with a plurality of antennas included in the receiving node 410 or the transmitting node 420 for transmitting downlink data. For example, the receiving node 410 (e.g., the UE) may identify a channel frequency response (CFR) based on at least one RS (e.g., CSI-RS) transmitted by the transmitting node 420 (e.g., the base station), and may, based on the identified CFR, identify at least one matrix associated with a plurality of transmit antennas included in the transmitting node 420 (e.g., the base station). As another example, the receiving node 410 (e.g., a base station) may identify a CFR associated with an uplink channel, based on at least one RS (e.g., SRS) transmitted by the transmitting node 420 (e.g., a UE), and may identify a CFR associated with a downlink channel, based on a reciprocal relationship between the uplink channel and the downlink channel. The receiving node 410 may identify at least one matrix associated with the plurality of transmit antennas included in the receiving node 410 (e.g., a base station), based on the identified CFR associated with the downlink channel.

According to an embodiment of the disclosure, the receiving node 410 (e.g., a base station or a UE) may, based on the received at least one RS, identify or calculate a CFR for each frequency domain and for each time domain.

For example, Equation 1 may be referred to as a CFR matrix (H[k,m]) including CFR components for each subcarrier and each orthogonal frequency division multiplexing (OFDM). In Equation 1, k may be referred to as a subcarrier index, m may be referred to as an OFDM symbol index in a single slot, Nₜ may be referred to as a number of transmission antenna ports of a base station, and Nᵣ may be referred to as a number of reception antenna ports of a UE. In Equation 1, n_{r,t}[k,m] may be referred to as a CFR value at a transmit antenna port index t, a receive antenna port index r, an OFDM symbol index m, and a subcarrier index k. The CFR matrix of Equation 1 may be a matrix of [symbol] ^{N}^{ᵣ}^{×N}^{ₜ}.

$$[ k , m ] = [ \begin{matrix}{η}_{1 , 1} [ k , m ] & {η}_{1 , 1} [ k , m ] & … & {η}_{1 , {N}_{t}} [ k , m ] \\ {η}_{2 , 1} [ k , m ] & {η}_{2 , 2} [ k , m ] & … & {η}_{2 , {N}_{t}} [ k , m ] \\ ⋮ & ⋮ & ⋱ & ⋮ \\ {η}_{{N}_{r} , 1} [ k , m ] & {η}_{{N}_{r} , 1} [ k , m ] & … & {η}_{{N}_{r} , {N}_{t}} [ k , m ]\end{matrix} ] {=}^{Δ} [ {h}_{1} [ k , m ] , … {h}_{{N}_{t}} [ k , m ] ] \qquad Equation 1$$

According to an embodiment of the disclosure, the receiving node 410 may identify, based on the identified CFR, at least one matrix associated with the plurality of antennas included in the receiving node 410 or the transmitting node 420 for transmitting downlink data. For example, the receiving node 410 may perform eigen decomposition on the CFR (or the CFR matrix), so as to obtain at least one matrix associated with the plurality of antennas included in the receiving node 410 or the transmitting node 420 for transmitting downlink data. For example, when the receiving node is a UE, the UE may obtain at least one matrix associated with plurality of antennas (e.g., the transmit antennas of base station) for transmitting downlink data by performing eigen decomposition on the CFR. For example, in a case in which the receiving node is a base station, the base station may obtain at least one matrix associated with a plurality of antennas (e.g., the transmit antennas of base station) for transmission of downlink data by performing eigen decomposition on the CFR.

The receiving node 410 may, based on a principal component analysis (PCA) technique, identify a CFR (or a CFR matrix) as a sum of products of a small number of eigen column vectors and Hermitian vectors of the eigen column vectors, in order to perform eigen decomposition on the CFR. For example, the receiving node 410 may identify a CFR matrix (H[k,m]), as shown in Equation 2.

In Equation 2,

$${η}_{r}^{H}$$

[k,m] may be the r-^{th} row matrix of H[k,m].

$$H [ k , m ] = [ \begin{matrix}{η}_{1 , 1} [ k , m ] & {η}_{1 , 1} [ k , m ] & … & {η}_{1 , {N}_{t}} [ k , m ] \\ {η}_{2 , 1} [ k , m ] & {η}_{2 , 2} [ k , m ] & … & {η}_{2 , {N}_{t}} [ k , m ] \\ ⋮ & ⋮ & ⋱ & ⋮ \\ {η}_{{N}_{r} , 1} [ k , m ] & {η}_{{N}_{r} , 1} [ k , m ] & … & {η}_{{N}_{r} , {N}_{t}} [ k , m ]\end{matrix} ] {=}^{Δ} [ \begin{matrix}{η}_{1}^{H} [ k , m ] \\ {η}_{2}^{H} [ k , m ] \\ ⋮ \\ {η}_{{N}_{r}}^{H} [ k , m ]\end{matrix} ] \qquad Equation 2$$

The receiving node 410 may perform eigen decomposition on the system matrix to obtain at least one vector (e.g., ψ[l]) associated with a plurality of antennas. For example, the receiving node 410 may obtain at least one vector (e.g., ψ[l]) associated with a plurality of antennas by performing eigen decomposition based on the CFR vector as in Equation 3 below.

$$\begin{matrix}Ψ {=}^{Δ} \frac{1}{{MKN}_{r}} {\sum }_{m} {\sum }_{k} {H}^{H} [ k , m ] H [ k , m ] \\ = \frac{1}{{MKN}_{r}} {\sum }_{m} {\sum }_{k} {\sum }_{r} {η}_{r} [ k , m ] {η}_{r}^{H} [ k , m ] = {\sum }_{l} λ [ l ] ψ [ l ] {ψ}^{H} [ l ]\end{matrix} \qquad Equation 3$$

In Equation 3,

$$\frac{1}{M K {N}_{r}} {\sum }_{m} {\sum }_{k} {\sum }_{r} {η}_{r} [ k , m ] {η}_{r}^{H} [ k , m ]$$

may be derived from the definition of H[k,m] that is a CFR matrix, and Σₗλ[l]ψ[l]ψ^{H}[l] may be derived by eigen decomposition. For reference, in Equation 3, λ[l] is the l-th eigenvalue, and satisfies the following Equation 4.

$$λ [ 1 ] \geq λ [ 2 ] \geq … \geq λ [ min ( {N}_{r} , {N}_{t} ) ] \geq 0 \qquad Equation 4$$

For reference, it is noted that the expression

$$Ψ {=}^{Δ} \frac{1}{M K {N}_{r}} {\sum }_{m} {\sum }_{k} {H}^{H} [ k , m ] H [ k , m ]$$

may substantially indicate taking an average of the product of a CFR matrix and a Hermitian matrix H of the CFR matrix. As a result, through the computation of

$$Ψ {=}^{Δ} \frac{1}{M K {N}_{r}} {\sum }_{m} {\sum }_{k} {H}^{H} [ k , m ] H [ k , m ] ,$$

frequency-domain characteristics and time-domain characteristics of elements included in the CFR matrix may be averaged.

For reference, the receiving node 410 may perform the eigen decomposition of a given matrix A by using Equation 5 below. For example, a vector (v) satisfying Equation 5 for a given matrix A may be referred to as an eigenvector, and a real value λ may be referred to as an eigenvalue.

$$A v - λ v = ( A - λ I ) v = 0 \qquad Equation 5$$

As a result, the receiving node 410 may obtain, based on the CFR (or the CFR matrix), at least one matrix associated with a plurality of antennas included in the receiving node 410 or the transmitting node 420 for transmitting downlink data. For example, it may be assumed that a rank configured between the receiving node 410 and the transmitting node 420 is 2 (or that the number of layers of a precoder is 2), and the receiving node 410 may obtain an eigenvalue matrix (or a wideband eigenvalue matrix) as shown in Equation 6 in the case where the rank is 2.

$$[ \begin{matrix}ψ [ 1 ] & ψ [ 2 ]\end{matrix} ] = [ \begin{matrix}{e}^{j {ζ}_{1}} {v}_{{i}_{1 , 1} {i}_{1 , 2}} & {e}^{j {ζ}_{2}} {v}_{{i}_{1 , 1} + {k}_{1} , {i}_{1 , 2} + {k}_{2}} \\ {e}^{j {ζ}_{1}} {φ}_{{i}_{2}} {v}_{{i}_{1 , 1} {i}_{1 , 2}} & - {e}^{j {ζ}_{2}} {φ}_{{i}_{2}} {v}_{{i}_{1 , 1} + {k}_{1} , {i}_{1 , 2} + {k}_{2}}\end{matrix} ] + E \qquad Equation 6$$

In Equation 6, ζ₁ and ζ₂ may be parameters for free running. For example, ζ₁ and ζ₂ may be parameters that do not affect v_{l,m}, which is a parameter related to beams formed by a plurality of antennas included in the receiving node 410 or the transmitting node 420 for transmitting downlink data. In Equation 6,

$${u}_{m} {=}^{Δ} {[ 1 , {e}^{j \frac{2 π m}{{O}_{2} {N}_{2}}} , … , {e}^{j \frac{2 π m ( {N}_{2} - 1 )}{{O}_{2} {N}_{2}}} ]}^{T} ∈ {ℂ}^{{N}_{2}}$$

may be a parameter related to vertical beams.

$${v}_{l , m} {=}^{Δ} {[ {u}_{m} , {u}_{m} {e}^{j \frac{2 π l}{{O}_{1} {N}_{1}}} , … , {u}_{m} {e}^{j \frac{2 π l ( {N}_{1} - 1 )}{{O}_{1} {N}_{1}}} ]}^{T} ∈ {ℂ}^{{N}_{1} {N}_{2}}$$

may be a parameter related to the vertical and horizontal beams. In Equation 6, O₁ may be a horizontal beam oversampling factor, N₁ may be the number of horizontal antenna ports, O₂ may be a vertical beam oversampling factor, and N₂ may be the number of vertical antenna ports. In Equation 6, E is an error matrix. k₁ and k₂ may be a value determined by i_{1,3}, which is an index indicating a relationship between layers of the precoder, and

$${φ}_{n} {=}^{△} {e}^{j \frac{2 π n}{4}}$$

may be co-phase.

According to an embodiment of the disclosure, at least one matrix associated with a plurality of antennas for transmitting downlink data may have a number of columns corresponding to a rank configured for the MIMO. For example, in Equation 6, a case in which the rank is 2 is assumed, so that at least one matrix may have two columns. As another example, in a case of a rank of 3, the at least one matrix associated with a plurality of antennas may have 3 columns.

According to an embodiment of the disclosure, the at least one matrix associated with a plurality of antennas for transmitting downlink data may be a matrix based on parameters of the plurality of antennas (e.g., transmit antennas of the base station 300) included in the receiving node 410 or the transmitting node 420 for transmitting downlink data. For example, at least one matrix associated with a plurality of antennas may be based on horizontal beams and vertical beams formed by the plurality of antennas of the base station 300, the phase difference between beams, the number of antenna ports for forming the horizontal beam, and/or the number of antenna ports for forming the vertical beam.

As another example, at least one matrix associated with a plurality of antennas (e.g., transmit antennas) of the base station 300 may include elements indicating the characteristics of the plurality of antennas (e.g., transmit antennas of the base station) for downlink data transmission. As another example, at least one matrix associated with a plurality of antennas of the base station 300 may include antenna-domain elements (or antenna-related parameter elements).

According to an embodiment of the disclosure, in operation 405, the receiving node 410 may convert the identified at least one matrix into values associated with angles of beams formed by a plurality of antennas included in the receiving node 410 or the transmitting node 420 for transmitting downlink data. For example, the receiving node 410 may perform 2D fast Fourier transform (2D FFT) for each of the elements included in at least one matrix to convert the same to values associated with angles. For example, the receiving node 410 may perform 2D FFT on at least one matrix to thereby convert elements of a matrix (matrices) associated with an antenna domain into values associated with angles. In an example, the values associated with the angles may substantially refer to angles of beams formed by a plurality of antennas (e.g., transmit antennas of a base station) included in the receiving node 410 or the transmitting node 420 for transmitting downlink data.

For example, the receiving node 410 may perform 2D FFT on respective elements of at least one matrix of Equation 6. Equation 7 may represent an expression for performing 2D FFT on a plurality of rows (e.g., a first row) and elements corresponding to a first column. Equation 8 may represent an expression for performing 2D FFT on a plurality of rows (e.g., a second row) and elements corresponding to a first column. Equation 9 may represent an equation for performing 2D FFT on a plurality of rows (e.g., a first row) and elements corresponding to a second column. Equation 10 may represent an expression for performing 2D FFT on a plurality of rows (e.g., a second row) and elements corresponding to a second column. It is to be noted that a plurality of rows (e.g., the first row) and elements corresponding to the first column of Equation 6 may be substantially associated with a first layer of the precoder and a first pole of polarization. A plurality of rows (e.g., the second row) and elements corresponding to the first column of Equation 6 may be substantially associated with a first layer of the precoder and a second pole. A plurality of rows (e.g., the first row) and elements corresponding to the second column may be substantially associated with a second layer of the precoder and a first pole. A plurality of rows (e.g., the second row) and elements corresponding to the second column may be substantially associated with the second layer and the second pole.

$${ζ}_{l , m}^{( 0 )} [ 1 ] {=}^{△} {\sum }_{q = 0}^{{N}_{2} - 1} {\sum }_{p = 0}^{{N}_{1} - 1} ψ [ 1 ] {\vert}_{{pN}_{2} + q + 1} {e}^{- j \frac{2 π lp}{{O}_{1} {N}_{1}}} {e}^{- j \frac{2 π mq}{{O}_{2} {N}_{2}}} \qquad Equation 7$$

$${ζ}_{l , m}^{( 1 )} [ 1 ] {=}^{△} {\sum }_{q = 0}^{{N}_{2} - 1} {\sum }_{p = 0}^{{N}_{1} - 1} ψ [ 1 ] {\vert}_{{pN}_{2} + q + {N}_{1} {N}_{2} + 1} {e}^{- j \frac{2 π lp}{{O}_{1} {N}_{1}}} {e}^{- j \frac{2 π mq}{{O}_{2} {N}_{2}}} \qquad Equation 8$$

$${ζ}_{l , m}^{( 0 )} [ 2 ] {=}^{△} {\sum }_{q = 0}^{{N}_{2} - 1} {\sum }_{p = 0}^{{N}_{1} - 1} ψ [ 2 ] {\vert}_{{pN}_{2} + q + 1} {e}^{- j \frac{2 π lp}{{O}_{1} {N}_{1}}} {e}^{- j \frac{2 π mq}{{O}_{2} {N}_{2}}} \qquad Equation 9$$

$${ζ}_{l , m}^{( 1 )} [ 2 ] {=}^{△} {\sum }_{q = 0}^{{N}_{2} - 1} {\sum }_{p = 0}^{{N}_{1} - 1} ψ [ 2 ] {\vert}_{{pN}_{2} + q + {N}_{1} {N}_{2} + 1} {e}^{- j \frac{2 π lp}{{O}_{1} {N}_{1}}} {e}^{- j \frac{2 π mq}{{O}_{2} {N}_{2}}} \qquad Equation 10$$

It may be noted that, in Equation 7 to Equation 10, p=0, 1, . . . , N₁−1, q=0, 1, . . . , N₂−1, l=0, 1, . . . , O₁N₁−1, and m=0, 1, . . . , O₂N₂−1.

In an example,

$${ζ}_{l , m}^{( 0 )} [ 1 ] , {ζ}_{l , m}^{( 1 )} [ 1 ] , {ζ}_{l , m}^{( 0 )} [ 2 ] , and {ζ}_{l , m}^{( 1 )} [ 2 ]$$

that have been received by the receiving node 410 may be respectively associated with the angles of beams formed by a plurality of antennas included in the receiving node 410 or the transmitting node 420 for transmitting downlink data. For example, in a case in which the receiving node 410 is a base station, the plurality of antennas for transmitting downlink data may be transmit antennas included in the receiving node 410. In a case in which the transmitting node 420 is a base station, the plurality of antennas for transmitting downlink data may be transmit antennas included in the transmitting node 420.

As a result, the receiving node 410 may perform 2D FFT on elements of at least one matrix belonging to the antenna domain to transform the elements into an angular domain of beams formed by a plurality of antennas (for example, transmit antennas of the base station). For example, the receiving node 410 may extract a physical angle of the beams from parameters associated with the characteristics of the plurality of antennas.

According to an embodiment of the disclosure, in operation 407, the receiving node 410 may determine at least one PMI applied to a plurality of antennas (for example, transmit antennas of the base station) for downlink data transmission, based on the values associated with the angles of the beams.

For example, the receiving node 410 may determine a first PMI corresponding to a first rank (e.g., rank 2) based on Equation 11. In Equation 11,

$${ζ}_{{i}_{1 , 1} , {i}_{1 , 2}}^{( 0 )} [ 1 ] + {e}^{- j \frac{2 π {i}_{2}}{4}} {ζ}_{{i}_{1 , 1} , {i}_{1 , 2}}^{( 1 )} [ 1 ]$$

may be substantially associated with data transmission from the transmitting node 420 (e.g., the base station) to the receiving node 410 (e.g., the UE) through a first layer.

$${ζ}_{{i}_{1 , 1} + {k}_{1} , {i}_{1 , 2} + {k}_{2}}^{( 0 )} [ 2 ] - {e}^{- j \frac{2 π {i}_{2}}{4}} {ζ}_{{i}_{1 , 1} + {k}_{1} , {i}_{1 , 2} + {k}_{2}}^{( 1 )} [ 2 ]$$

may be associated with data transmission from the transmitting node 420 (e.g., a base station) to the receiving node 410 (e.g., a UE) through a second layer. Therefore, Equation 11 may be referred to as an equation for obtaining a PMI at which the data throughput through the first layer and the second layer is maximized.

$$( {i}_{1 , 1}^{⋆} , {i}_{1 , 2}^{⋆} , {i}_{2}^{⋆} , {i}_{1 , 3}^{⋆} ) = arg {max}_{{i}_{1 , 1} , {i}_{1 , 2} , {i}_{2} ( {k}_{1} , {k}_{2} ) = f ( {i}_{1 , 3} )} {ω}_{1} \vert {ζ}_{{i}_{1 , 1} , {i}_{1 , 2}}^{( 0 )} [ 1 ] + {e}^{- j \frac{2 π {i}_{2}}{4}} {ζ}_{{i}_{1 , 1} , {i}_{1 , 2}}^{( 1 )} [ 1 ] \vert + {ω}_{2} \vert {ζ}_{{i}_{1 , 1} + {k}_{1} , {i}_{1 , 2} + {k}_{2}}^{( 0 )} [ 2 ] - {e}^{- j \frac{2 π {i}_{2}}{4}} {ζ}_{{i}_{1 , 1} + {k}_{1} , {i}_{1 , 2} + {k}_{2}}^{( 1 )} [ 2 ] \vert \qquad Equation 11$$

For reference, in Equation 11, k₁, k₂ is a value determined by a value of i_{1,3}, and ω₁ and ω₂ are weight parameters. For example, the receiving node 410 may adjust a PMI corresponding to a rank (e.g., rank 2) through a weight parameter. For example, when the receiving node 410 configures, as 1, a weight (ω₁) for the first layer and configures, as 0, a weight (ω₂) for the second layer, the PMI obtained by the receiving node 410 may be a value calculated by considering only data transmission through the first layer.

As a result, the receiving node 410 may identify or obtain a PMI for a specified rank (e.g., rank 2). Similarly, the receiving node 410 may identify or calculate multiple PMIs corresponding to a plurality of ranks configured for the receiving node 410 or the transmitting node 420. In other words, the receiving node 410 may perform 2D FFT on at least one matrix having a plurality of rows (e.g., two rows) and three columns with regard to a second rank (e.g., rank 3) to acquire values associated with the angles. The receiving node 410 may identify a PMI that provides maximum data throughput for each of a first layer to a third layer based on the values associated with the angles. The identified PMI may correspond to a second rank (e.g., rank 3).

According to an embodiment of the disclosure, the determined PMI may include multiple indices. For example, the determined PMI may include an index (i_{1,2}) indicating an angle of a vertical beam of a new radio (NR) type 1 precoder, an index (i_{1,1}) indicating an angle of a horizontal beam of the NR type 1 precoder, an index (i₂) indicating a phase (or phase difference) between antennas of different poles, and/or an index (i_{1,3}) indicating a relationship between layers when the NR type 1 precoder has multiple layers.

According to an embodiment of the disclosure, the at least one PMI identified or calculated by the receiving node 410 may be one or multiple. For example, the receiving node 410 may calculate or identify a PMI for each rank configured for multiple-input and multiple-output (MIMO). For example, in case that one rank is configured for the receiving node 410, the receiving node 410 may calculate or identify one PMI. In case that the rank configured for the receiving node 410 is plural, the receiving node 410 may calculate or identify a PMI corresponding to each of the plural ranks.

According to an embodiment of the disclosure, the at least one PMI calculated or identified by the receiving node 410 may be referred to as a PMI to be applied or applicable to the transmitting node 420.

According to an embodiment of the disclosure, in operation 409, the receiving node 410 may transmit information on a first PMI corresponding to a maximum downlink data throughput from the at least one PMI.

For example, the receiving node 410 (e.g., a UE) may acquire multiple PMIs corresponding to multiple ranks, respectively, when multiple ranks are configured. For example, the receiving node 410 (e.g., a UE) may acquire a first PMI corresponding to a first rank (e.g., rank 2), a second PMI corresponding to a second rank (e.g., rank 3), and a third PMI corresponding to a third rank (e.g., rank 4). The receiving node 410 (e.g., the UE) may select an optimal PMI among the first PMI, the second PMI, and the third PMI, and identify the selected optimal PMI. For example, the optimal PMI may correspond to a PMI that corresponds to a maximum downlink data throughput. For example, the optimal PMI from at least one PMI may be referred to as a PMI having the highest data throughput in communication between the receiving node 410 and the transmitting node 420.

According to an embodiment of the disclosure, when the first PMI from the at least one PMI is identified as the optimal PMI, the receiving node 410 (e.g., a UE) may transmit information on the first PMI to the transmitting node 420 (e.g., a base station).

However, when the receiving node 410 is a base station, the receiving node 410 may omit the operation of transmitting the information on the first PMI to the transmitting node 420 (e.g., a UE), and the receiving node 410 may transmit downlink data to the transmitting node 420 (e.g., a UE), based on the identified first PMI. As another example, when the receiving node 410 is a base station, the receiving node 410 may transmit information on the identified first PMI to the transmitting node 420 (e.g., a UE) before downlink data transmission.

According to an embodiment of the disclosure, information on the first PMI may indicate a downlink channel state between the transmitting node 420 and the receiving node 410.

In operation 407 of the disclosure, it has been described that the receiving node 410 determines at least one PMI applicable to a plurality of antennas (e.g., transmit antennas of a base station) for downlink data transmission, based on values associated with the angles of beams through Equation 11, but this is merely an example. For example, when the rank is 2, the receiving node 410 may calculate or identify

$$( {i}_{1 , 1}^{⋆} , {i}_{1 , 2}^{⋆} , {i}_{2}^{⋆} )$$

among indices included in the PMI through Equation 12, which is associated with a first layer. The receiving node 410 may determine i_{1,3}* among indices included in the PMI through Equation 13, based on the calculated or identified

$$( {i}_{1 , 1}^{⋆} , {i}_{1 , 2}^{⋆} , {i}_{2}^{⋆} ) .$$

$$( {i}_{1 , 1}^{⋆} , {i}_{1 , 2}^{⋆} , {i}_{2}^{⋆} ) = arg {max}_{{i}_{1 , 1} , {i}_{1 , 2} , {i}_{2}} \vert {ζ}_{{i}_{1 , 1} , {i}_{1 , 2}}^{( 0 )} [ 1 ] + {e}^{- j \frac{2 π {i}_{2}}{4}} {ζ}_{{i}_{1 ,} , {i}_{1 , 2}}^{( 1 )} [ 1 ] \vert \qquad Equation 12$$

$$Equation 13$$

$${i}_{1 , 3}^{⋆} = arg {max}_{( {k}_{1} , {k}_{2} ) = f ( {i}_{1 , 3} )} \vert {ζ}_{{i}_{1 , 1}^{⋆} + {k}_{1} , {i}_{1 , 2}^{⋆} + {k}_{2}}^{( 0 )} [ 2 ] - {e}^{- j \frac{2 π {i}_{2}^{⋆}}{4}} {ζ}_{{i}_{1 , 1}^{⋆} + {k}_{1} , {i}_{1 , 2}^{⋆} + {k}_{2}}^{( 1 )} [ 2 ] \vert$$

Consequently, the method in which the receiving node 410 calculates or identifies a PMI corresponding to a rank (e.g., rank 2) based on values associated with the angles of the beams is not limited to the methods of Equation 11 or Equations 12 to 13.

In operations 405 and 409 of the disclosure, operations in which the receiving node 410 converts at least one matrix into values associated with angles of beams and determines a PMI, based on the values associated with the angles of beams may correspond to a case in which the receiving node 410 (e.g., a UE) is configured to perform wideband PMI reporting. As another example, in case that the receiving node 410 is a base station, the receiving node 410 may not receive a separate PMI configuration.

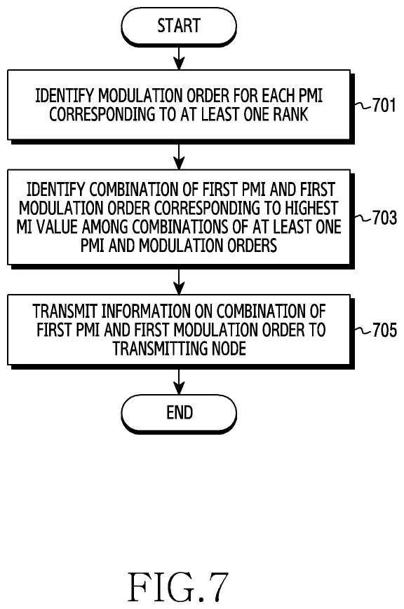

The receiving node 410 (e.g., a UE) may be configured to report a subband PMI through radio resource control (RRC) signaling, and a method of identifying the subband PMI will be described below with reference to FIG. 7B. As another example, when the receiving node 410 is a base station, a process in which the subband PMI is configured to be reported through separate RRC signaling may be omitted.

The PCA technique described in the disclosure is illustratively described to perform eigen decomposition with regard to a CFR (or a CFR matrix), and the PCA technique is not essential but is illustrative.

FIG. 4C illustrates a method in which a receiving node transmits, based on a type of PMI report, information including different types of information elements (IEs) to a transmitting node, according to an embodiment of the disclosure.

Referring to FIG. 4C, the receiving node 410 may be assumed to correspond to a UE 200, and the transmitting node 420 may be assumed to correspond to a base station 300. For example, a case in which the receiving node 410 receives a type of PMI report via RRC signaling may substantially correspond to a case in which the receiving node 410 is the UE 200. Consequently, in the embodiment illustrated in FIG. 4C, the receiving node 410 may be assumed to be the UE 200, and the transmitting node 420 may be assumed to be the base station 300.

Referring to FIG. 4C, the receiving node 410 (e.g., a UE) according to an embodiment of the disclosure may receive configuration information associated with PMI reporting in operation 411. For example, the receiving node 410 (e.g., a UE) may receive configuration information associated with PMI reporting from the transmitting node 420 (e.g., a base station) through RRC signaling.

According to an embodiment of the disclosure, the configuration information associated with PMI reporting may include information regarding a type of a PMI report that the receiving node 410 (e.g., the UE) should transmit. For example, the configuration information associated with PMI reporting may include information on whether the receiving node 410 (e.g., the UE) is configured to report only a wideband PMI to the transmitting node 420 (e.g., the base station) or information on whether the receiving node 410 (e.g., the UE) is configured to report a wideband PMI and a subband-specific PMI to the transmitting node 420 (e.g., the base station).

According to an embodiment of the disclosure, in operation 413, the receiving node 410 (e.g., a UE) may determine a first PMI from at least one PMI determined based on values associated with the angles of the beams. Operation 413 of FIG. 4C may substantially correspond to operations 401 to 407 of FIG. 4B.

For example, in operation 413, the receiving node 410 (e.g., the UE) may identify a CFR (or a CFR matrix), based on the received at least one RS, and may, based on the identified CFR, identify at least one matrix associated with a plurality of antennas (e.g., transmit antennas of the base station) included in the transmitting node 420 for transmitting downlink data. The receiving node 410 may convert at least one matrix into values associated with the angles of the beams, and may determine at least one PMI applicable to the transmitting node 420 (e.g., a base station), based on the values associated with the angles of the beams. The receiving node 410 (e.g., the UE) may determine a first PMI corresponding to a maximum data throughput from at least one PMI.

According to an embodiment of the disclosure, the operation of the receiving node 410 (e.g., the UE) determining the first PMI may be substantially understood as an operation of the receiving node 410 (e.g., the UE) determining a wideband PMI to report to the transmitting node 420 (e.g., the base station).

According to an embodiment of the disclosure, the receiving node 410 (e.g., the UE) may determine, in operation 415, whether the receiving node 410 is configured to report only a wideband PMI. For example, the configuration information associated with PMI reporting received from the transmitting node 420 (e.g., base station) may include a field regarding the type of a PMI report, and the receiving node 410 (e.g., UE) may determine whether the receiving node 410 (e.g., base station) is configured to report only the wideband PMI or to report both the wideband PMI and the subband-specific PMI, based on the field value regarding the type of the PMI report.

According to an embodiment of the disclosure, in a case in which the receiving node 410 (e.g., a UE) is configured to report only a wideband PMI, the receiving node 410 (e.g., a UE) may transmit information on a first PMI from at least one PMI to the transmitting node 420 (e.g., a base station) in operation 417.

Operation 417 of FIG. 4C may correspond to operation 409 of FIG. 4B.

According to an embodiment of the disclosure, when the receiving node 410 (e.g., the UE) is configured to report a wideband PMI and a subband-specific PMI, the receiving node 410 (e.g., the UE) may determine the subband-specific PMI, based on the first PMI, in operation 419.

According to an embodiment of the disclosure, the receiving node 410 may determine a subband-specific PMI, based on the identified wideband PMI (e.g., first PMI).

For example, when the rank is 2, a subband-specific matrix may be expressed as Equation 13-1 below. A subband-specific matrix may be substantially referred to as a matrix associated with a plurality of antennas included in the transmitting node 420 (e.g., a base station) for transmitting downlink data. In Equation 13-1, index i₂(s) may be a function of SB s.

$$Equation 13 - 1$$

$$[ \begin{matrix}{ψ}_{s} [ 1 ] & {ψ}_{s} [ 2 ]\end{matrix} ] = [ \begin{matrix}{e}^{j {ζ}_{1}} {v}_{{i}_{1 , 1} , {i}_{1 , 2}} & {e}^{j {ζ}_{2}} {v}_{{i}_{1 , 1} + {k}_{1} , {i}_{1 , 2} + {k}_{2}} \\ {e}^{j {ζ}_{1}} {φ}_{{i}_{2} ( s )} {v}_{{i}_{1 , 1} , {i}_{1 , 2}} & - {e}^{j {ζ}_{2}} {φ}_{{i}_{2} ( s )} {v}_{{i}_{1 , 1} + {k}_{1} , {i}_{1 , 2} + {k}_{2}}\end{matrix} ] + E$$

The receiving node 410 may perform 2D FFT on each of the elements of the subband-specific matrix. For example, Equation 14 represents a case in which 2D FFT is performed on an element (e.g., ψₛ[1]|_{pN}_{₂}_{+q+1}) corresponding to the first layer and the first pole. Equation 15 represents a case in which 2D FFT is performed on an element (e.g., ψₛ[1]|_{pN}_{₂}_{+q+N}_{₁}_{N}_{₂}₊₁) corresponding to the first layer and the second pole. Equation 16 represents a case in which 2D FFT is performed on an element (e.g., ψₛ[2]|_{pN}_{₂}_{+q+1}) corresponding to the second layer and the first pole. Equation 17 represents a case in which 2D FFT is performed on an element (for example, ψₛ[2]|_{pN}_{₂}_{+q+N}_{₁}_{N}_{₂}₊₁) corresponding to the second layer and the second pole.

$${ζ}_{l , m , s}^{( 0 )} [ 1 ] {=}^{△} {\sum }_{q = 0}^{{N}_{2} - 1} {\sum }_{p = 0}^{{N}_{1} - 1} {ψ}_{s} [ 1 ] {\vert}_{{pN}_{2} + q + 1} {e}^{- j \frac{2 π lp}{{O}_{1} {N}_{1}}} {e}^{- j \frac{2 π mq}{{O}_{2} {N}_{2}}} \qquad Equation 14$$

$${ζ}_{l , m , s}^{( 1 )} [ 1 ] {=}^{△} {\sum }_{q = 0}^{{N}_{2} - 1} {\sum }_{p = 0}^{{N}_{1} - 1} {ψ}_{s} [ 1 ] {\vert}_{{pN}_{2} + q + {N}_{1} {N}_{2} + 1} {e}^{- j \frac{2 π lp}{{O}_{1} {N}_{1}}} {e}^{- j \frac{2 π mq}{{O}_{2} {N}_{2}}} \qquad Equation 15$$

$${ζ}_{l , m , s}^{( 0 )} [ 2 ] {=}^{△} {\sum }_{q = 0}^{{N}_{2} - 1} {\sum }_{p = 0}^{{N}_{1} - 1} {ψ}_{s} [ 2 ] {\vert}_{{pN}_{2} + q + 1} {e}^{- j \frac{2 π lp}{{O}_{1} {N}_{1}}} {e}^{- j \frac{2 π mq}{{O}_{2} {N}_{2}}} \qquad Equation 16$$

$${ζ}_{l , m , s}^{( 1 )} [ 2 ] {=}^{△} {\sum }_{q = 0}^{{N}_{2} - 1} {\sum }_{p = 0}^{{N}_{1} - 1} {ψ}_{s} [ 2 ] {\vert}_{{pN}_{2} + q + {N}_{1} {N}_{2} + 1} {e}^{- j \frac{2 π lp}{{O}_{1} {N}_{1}}} {e}^{- j \frac{2 π mq}{{O}_{2} {N}_{2}}} \qquad Equation 17$$

The receiving node 410 may identify a subband-specific PMI

$$( e . g . , {i}_{2}^{⋆} ( s ) )$$

that maximizes a data throughput of each of the first and second layers, based on the wideband PMI

$$( e . g . , {i}_{1 , 1}^{⋆} , {i}_{1 , 2}^{⋆} , {i}_{2}^{⋆} )$$

and/or the converted values

$$( e . g . , {ζ}_{l , m , s}^{( 0 )} [ 1 ] , {ζ}_{l , m , s}^{( 1 )} [ 1 ] , {ζ}_{l , m , s}^{( 0 )} [ 2 ] , {ζ}_{l , m , s}^{( 1 )} [ 2 ] ) .$$

For example, the receiving node 410 may substitute a wideband PMI into Equation 18 and may identify or obtain a subband-specific PMI

$$( e . g . , {i}_{2}^{⋆} ( s ) ) .$$

$${i}_{2}^{*} ( s ) = arg {max}_{{i}_{2} ( s )} {ω}_{1} \vert {ζ}_{{i}_{1 , 1}^{*} , {i}_{1 , 2}^{*} , s}^{( 0 )} [ 1 ] + {e}^{- j \frac{2 π {i}_{2} ( s )}{4}} {ζ}_{{i}_{1 , 1}^{*} , {i}_{1 , 2}^{*} , s}^{( 1 )} [ 1 ] \vert + {ω}_{2} \vert {ζ}_{{i}_{1 , 1}^{*} + {k}_{1}^{*} , {i}_{1 , 2}^{*} + {k}_{2}^{*} , s}^{( 0 )} [ 2 ] - {e}^{- j \frac{2 π {i}_{2} ( s )}{4}} {ζ}_{{i}_{1 , 1}^{*} + {k}_{1}^{*} , {i}_{1 , 2}^{*} + {k}_{2}^{*} , s}^{( 1 )} [ 2 ] \vert \qquad Equation 18$$

For reference, in Equation 18, ω₁ and ω₂ may be weight parameters.

According to an embodiment of the disclosure, a wideband PMI and a subband-specific PMI may each correspond to a designated rank. For example, a first PMI that is a wideband PMI determined in operation 413, and a subband-specific PMI determined based on the first PMI in operation 419 may correspond to the first rank (e.g., rank 2).

According to an embodiment of the disclosure, the receiving node 410 (e.g., the UE) may transmit information on a first PMI and information on a subband-specific PMI to the transmitting node 420 (e.g., the base station) in operation 421. For example, a message (e.g., an RRC message) for PMI reporting transmitted by the receiving node 410 (e.g., a UE) to the transmitting node 420 (e.g., a base station) may include an IE for a first PMI corresponding to a wideband PMI and IEs for subband-specific PMIs.

In the disclosure, it has been described that the receiving node 410 determines a subband-specific PMI through Equation 18, but this is merely an example. For example, the receiving node 410 may determine a subband-specific PMI

$$( e . g . , {i}_{2}^{⋆} ( s ) ) )$$

based only on the first layer. For example, the receiving node 410 may determine a subband-specific PMI, based on Equation 19.

$${i}_{2}^{⋆} ( s ) = arg {max}_{{i}_{2} ( s )} \vert {ζ}_{{i}_{1 , 1}^{*} , {i}_{1 , 2}^{*} , s}^{( 0 )} [ 1 ] + {e}^{- j \frac{2 π {i}_{2} ( s )}{4}} {ζ}_{{i}_{1 , 1}^{*} , {i}_{1 , 2}^{*} , s}^{( 1 )} [ 1 ] \vert \qquad Equation 19$$

As a result, the method in which the receiving node 410 calculates or identifies a PMI corresponding to a rank (e.g., rank 2), based on values associated with angles of beams is not limited to the method of Equation 11 or the methods of Equations 12 to 13.

According to an embodiment of the disclosure, when the receiving node 410 (e.g., the UE) is configured to report a wideband PMI, information associated with a PMI transmitted to the transmitting node 420 (e.g., the base station) may include information on an angle of at least one horizontal beam associated with a plurality of antennas included in the transmitting node 420 for transmitting downlink data, information on an angle of at least one vertical beam associated with the plurality of antennas, and/or information on a phase (e.g., co-phase information) associated with a plurality of antennas.

According to an embodiment of the disclosure, when the receiving node 410 (e.g., the UE) is configured to report a subband PMI, information associated with a PMI transmitted to the transmitting node 420 (e.g., the base station) may include information on an angle of at least one horizontal beam, information on an angle of at least one vertical beam, and/or information on a subband-specific phase.

As a result, when the receiving node 410 (e.g., a UE) is configured to report a subband PMI, the receiving node 410 may transmit more information on a subband-specific phase to the transmitting node 420 (e.g., the base station) than when the receiving node 410 is configured to report a wideband PMI.

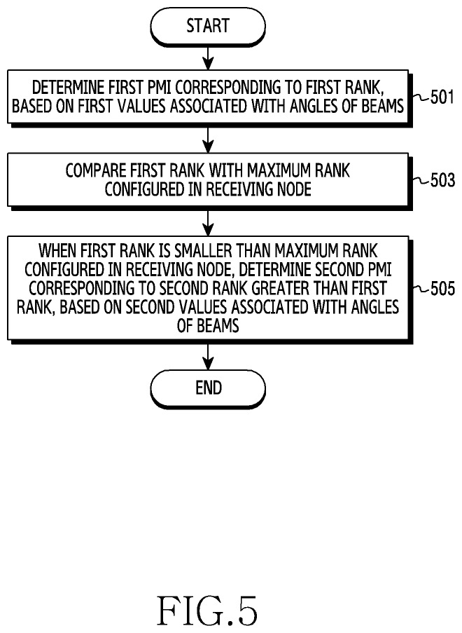

FIG. 5 illustrates a method in which a receiving node determines multiple PMIs according to an embodiment of the disclosure.

Referring to FIG. 5, the receiving node 410 (e.g., a base station or a UE) according to an embodiment of the disclosure may determine a first PMI corresponding to a first rank (e.g., rank 2) based on first values associated with angles of beams in operation 501. For example, the receiving node 410 may identify a first matrix (e.g., a matrix having a plurality of rows and two columns) associated with a plurality of antennas included in the receiving node 410 or the transmitting node 420 for transmitting downlink data, and may convert the first matrix associated with the plurality of antennas (e.g., transmit antennas of the base station) into first values associated with angles of beams. The receiving node 410 may determine a first PMI, based on the first values associated with the angles of the beams. The first PMI may correspond to the first rank (e.g., rank 2).

According to an embodiment of the disclosure, the receiving node 410 may compare the first rank (e.g., rank 2) with a maximum rank configured for the receiving node 410 in operation 503. For example, the maximum rank may be configured for the receiving node 410 (e.g., the UE 200) through RRC signaling. As another example, the maximum rank may be preconfigured for the receiving node 410 (for example, the base station 300).

According to an embodiment of the disclosure, in a case in which the first rank configured for the receiving node 410 is the same as the maximum rank, the receiving node 410 may transmit information on a first PMI corresponding to the first rank smaller than the maximum rank to the transmitting node 420. The transmitting node 420 (e.g., the base station 300) may receive information on the first PMI, and may transmit data to the receiving node 410 (e.g., the UE 200) based on the first PMI.

However, in case that the receiving node 410 is a base station and the transmitting node 420 is a UE, the receiving node 410 (e.g., the base station) may omit the operation of transmitting the information on the first PMI to the transmitting node 420 (e.g., the UE). For example, the base station may, instead of transmitting information on the first PMI, transmit downlink data to the UE, based on the identified first PMI.

According to an embodiment of the disclosure, in operation 505, when the first rank (e.g., rank 2) is smaller than a maximum rank configured for the receiving node, the receiving node 410 may determine a second PMI corresponding to a second rank (e.g., rank 3) greater than the first rank, based on second values associated with the angles of the beams. For example, the receiving node 410 may identify a second matrix (e.g., a matrix with a plurality of rows and three columns) associated with a plurality of antennas included in the receiving node 410 or the transmitting node 420 for transmitting downlink data, and may convert the second matrix associated with the plurality of antennas (e.g., transmit antennas of the base station) into second values associated with the angles of the beams. The receiving node 410 may determine the second PMI, based on the second values associated with the angles of the beams. The second PMI may correspond to the second rank (e.g., rank 3).

According to an embodiment of the disclosure, the receiving node 410 may determine multiple PMIs in a manner substantially the same as that described in operations 501 to 503. For example, the receiving node 410 may compare the configured maximum rank with the second rank (e.g., rank 3) after operation 505, and may stop the additional PMI calculation in case that the maximum rank is greater than the second rank (e.g., rank 3). The receiving node 410 may determine one of the first PMI and the second PMI as a PMI to be transmitted to the transmitting node 420 (e.g., the base station 300).

However, in the case that the receiving node 410 is a base station and the transmitting node 420 is a UE, the receiving node 410 (e.g., the base station) may omit the operation of transmitting information on the first PMI or information on the second PMI to the transmitting node 420 (e.g., the UE). For example, the base station may transmit downlink data to the UE, based on the identified optimal PMI (e.g., the first PMI or the second PMI), instead of performing an operation of transmitting information on the first PMI or the second PMI.

The receiving node 410 may determine a third PMI corresponding to a third rank (e.g., rank 4) in the same manner as in operation 501 or 505 in case that the maximum rank is greater than a second rank (e.g., rank 3). Thereafter, in case that the maximum rank is greater than the third rank, the receiving node 410 may determine one of the first PMI, the second PMI, and the third PMI as a PMI to be transmitted to the transmitting node 420.

Operations 501 to 505 of FIG. 5 of the disclosure may replace operations 403 to 407 of FIG. 4B. Therefore, the embodiment of FIG. 5 may be combined with the embodiment of FIGS. 4A, 4B, and 4C. However, the combination relations between the operations in FIGS. 4A, 4B, 4C, and 5 are merely illustrative, and do not limit the disclosure.

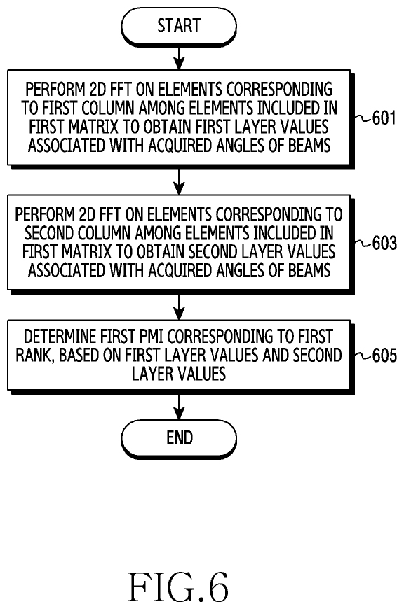

FIG. 6 illustrates a method in which a receiving node determines a first PMI according to an embodiment of the disclosure.

Referring to FIG. 6, in operation 601, a receiving node 410 (e.g., a UE or a base station) according to an embodiment of the disclosure may perform 2D FFT on elements corresponding to a first column among elements included in a first matrix (e.g., a matrix having a plurality of rows and two columns) to obtain or identify first layer values associated with angles of beams. For example, the receiving node 410 may perform 2D FFT on elements (e.g., e^{jζ}^{₁}vᵢ_{_{1,1}}_{,i}_{_{1,2}}, e^{jζ}^{₁}φᵢ_{₂}vᵢ_{_{1,1}}_{,i}_{_{1,2}}) corresponding to the first column of the first matrix to obtain or identify first layer values

$$( e . g . , {ζ}_{l , m}^{( 0 )} [ 1 ] , {ζ}_{l , m}^{( 1 )} [ 1 ] ) .$$

$$[ \begin{matrix}ψ [ 1 ] & ψ [ 2 ]\end{matrix} ] = [ \begin{matrix}{e}^{j {ζ}_{1}} {v}_{{i}_{1 , 1} , {i}_{1 , 2}} & {e}^{j {ζ}_{2}} {v}_{{i}_{1 , 1} + {k}_{1} , {i}_{1 , 2} + {k}_{2}} \\ {e}^{j {ζ}_{1}} {φ}_{{i}_{2}} {v}_{{i}_{1 , 1} , {i}_{1 , 2}} & - {e}^{j {ζ}_{2}} {φ}_{{i}_{2}} {v}_{{i}_{1 , 1} + {k}_{1} , {i}_{1 , 2} + {k}_{2}}\end{matrix} ] + E \qquad Equation 6$$

According to an embodiment of the disclosure, in operation 603, the receiving node 410 may perform 2D FFT on the elements corresponding to the second column (e.g., e^{jζ}^{₂}vᵢ_{_{1,1}}₊ₖ_{₁}_{,i}_{_{1,2}}₊ₖ_{₂}, −e^{jζ}^{₂}φᵢ_{_{1,1}}₊ₖ_{₁}_{,i}_{_{1,2}}₊ₖ_{₂}) among the elements included in the first matrix to obtain or identify second layer values

$$( e . g . , {ζ}_{l , m}^{( 0 )} [ 2 ] , {ζ}_{l , m}^{( 1 )} [ 2 ] ) .$$

According to an embodiment of the disclosure, the receiving node 410 may determine a first PMI corresponding to a first rank, based on the first layer values and the second layer values. For example, the receiving node 410 may identify a PMI at which the sum of a data throughput transmitted through the first layer and a data throughput transmitted through the second layer is maximized, based on the first layer values and the second layer values. The receiving node 410 may determine, as a first PMI corresponding to a first rank, a PMI at which the sum of the data throughputs is maximized.

For example, the receiving node 410 may substitute the first layer values and the second layer values into Equation 11 and may determine, as a first PMI corresponding to a first rank, a PMI at which the sum of the data throughputs is maximized.

$$( {i}_{1 , 1}^{*} , {i}_{1 , 2}^{*} , {i}_{2}^{*} , {i}_{1 , 3}^{*} ) = arg {max}_{{i}_{1 , 1} , {i}_{1 , 2} , {i}_{2} ( {k}_{1} , {k}_{2} ) = f ( {i}_{1 , 3} )} {ω}_{1} \vert {ζ}_{{i}_{1 , 1} , {i}_{1 , 2}}^{( 0 )} [ 1 ] + {e}^{- j \frac{2 π {i}_{2}}{4}} {ζ}_{{i}_{1 , 1} , {i}_{1 , 2}}^{( 1 )} [ 1 ] \vert + {ω}_{2} \vert {ζ}_{{i}_{1 , 1} + {k}_{1} , {i}_{1 , 2} + {k}_{2}}^{( 0 )} [ 2 ] - {e}^{- j \frac{2 π {i}_{2}}{4}} {ζ}_{{i}_{1 , 1} + {k}_{1} , {i}_{1 , 2} + {k}_{2}}^{( 1 )} [ 2 ] \vert \qquad Equation 11$$

In operations 601 to 605 of FIG. 6 of the disclosure, a method in which the receiving node 410 identifies or determines a first PMI corresponding to a first rank (e.g., rank 2) has been described, but this is only an example. The receiving node 410 may identify or determine other PMIs (e.g., the second PMI, the third PMI, and the fourth PMI) using a method substantially the same as the method described in operations 601 to 605.

FIG. 7 illustrates a method of transmitting, to a transmitting node, information on a combination of a PMI and a modulation order corresponding to the highest MI value according to an embodiment of the disclosure.

Referring to FIG. 7, the receiving node 410 is assumed to correspond to a UE 200, and the transmitting node 420 is assumed to correspond to a base station 300.

Referring to FIG. 7, the receiving node 410 (e.g., the UE) according to an embodiment of the disclosure may identify a modulation order for each of at least one PMI corresponding to at least one rank in operation 701. For example, the receiving node 410 (e.g., the UE) may identify a first PMI corresponding to a first rank (e.g., rank 2), a second PMI corresponding to a second rank (e.g., rank 3), a third PMI corresponding to a third rank (e.g., rank 4), and a fourth PMI corresponding to a fourth rank (e.g., rank 5).

According to an embodiment of the disclosure, the receiving node 410 (e.g., the UE) may identify an optimal modulation order with regard to the first PMI. For example, when the first PMI is applied to the transmitting node 420, the modulation order corresponding to the highest data throughput (or MI value) may be 16QAM (quadrature amplitude modulation). The modulation order corresponding to the highest data throughput when the second PMI is applied to the transmitting node 420 may be 64QAM. The modulation order corresponding to the highest data throughput when the third PMI is applied to the transmitting node 420 may be 256QAM. When the fourth PMI is applied to the transmitting node 420 (e.g., the base station), the modulation order corresponding to the highest data throughput may be quadrature phase shift keying (QPSK).

As a result, the modulation order (or the optimal modulation order) for the first PMI may be 16QAM, the modulation order for the second PMI may be 64QAM, the modulation order for the third PMI may be 256QAM, and the modulation order for the fourth PMI may be QPSK.

According to an embodiment of the disclosure, in operation 703, the receiving node 410 may identify a combination of a first PMI and a first modulation order which corresponds to the highest MI value, among the combination of at least one PMI and a modulation order.

For example, the receiving node 410 may identify a first combination of a first PMI and a first modulation order (e.g., 16QAM), a second combination of a second PMI and a second modulation order (e.g., 64QAM), a third combination of a third PMI and a third modulation order (e.g., 256QAM), and a fourth combination of a fourth PMI and a fourth modulation order (e.g., QPSK). The receiving node 410 may identify that the first combination corresponds to the highest MI value among the first to fourth combinations.

For example, the receiving node 410 may identify that a first combination among the multiple combinations is able to increase the data throughput in communication between the transmitting node 420 (e.g., the base station 300) and the receiving node 410 (e.g., the UE 200) the most.

According to an embodiment of the disclosure, in operation 705, the receiving node 410 may transmit information on a combination of the first PMI and the first modulation order to the transmitting node 420 (e.g., the base station 300). For example, the receiving node 410 may perform PMI reporting to the transmitting node 420 (e.g., the base station), and a message for the PMI reporting may include a field for indicating the first PMI and a field for indicating the first modulation order (e.g., 16QAM).

According to an embodiment of the disclosure, the MI value may be an indicator or parameter indicating a data throughput in communication between the transmitting node 420 (e.g., a base station) and the receiving node 410 (e.g., a UE). For example, the MI value may be determined based on at least one of a modulation order, at least one rank, a subcarrier index, and a symbol index in a slot, which are used for communication between the transmitting node 420 (e.g., a base station) and the receiving node 410 (e.g., a UE).

For example, the MI value may be indicated as shown in Equation 13-2.

$$MI ( {i}_{1 , 1} , {i}_{1 , 2} , {i}_{1 , 3} , {i}_{2} ( s ) , Q , B ) = {\sum }_{m} {\sum }_{k} {\sum }_{b} {μ}_{Q} ( {pSNR}_{b} {=}^{Δ} \frac{{g}_{b}^{H} [ k , m ] {( G [ k , m ] {G}^{H} [ k , m ] + {σ}_{z}^{2} I )}^{- 1} {g}_{b} [ k , m ]}{1 - {g}_{b}^{H} [ k , m ] {( G [ k , m ] {G}^{H} [ k , m ] + {σ}_{z}^{2} I )}^{- 1} {g}_{b} [ k , m ]} ) \qquad Equation 13 - 2$$

In Equation 13-2, Q denotes a modulation order, S denotes the number of layers (or the number of ranks), pSNR_{b} denotes a post signal to noise ratio (pSNR) of layer b in the receiving node 410 (e.g., the UE) using minimum mean square error (MMSE), and μ_{Q}(⋅) denotes the MI of a single layer when the modulation order of the single layer is Q.

In addition, the valid CFR matrix (G[k,m]) may be indicated as in Equation 14-1 below.

$$G [ k , m ] = H [ k , m ] {W}_{{i}_{1 , 1} , {i}_{1 , 2} , {i}_{1 , 3} , {i}_{2} ( s = ⌊ k / {N}_{R E}^{SB} ⌋ )} [ s ] {=}^{Δ} [ {g}_{1} [ k , m ] , … {g}_{b} [ k , m ] ] ∈ {ℂ}^{{N}_{r} \times B} \qquad Equation 14 - 1$$

For reference, in Equation 14-1, s denotes an SB index,

$${N}_{RE}^{S B}$$

denotes the number of resource elements (REs) included in one SB, i_{1,1} denotes an index indicating a horizontal beam angle of an NR Type-1 precoder, i_{1,2} denotes an index indicating a vertical beam angle of the NR Type-1 precoder, i_{1,3} denotes an index indicating a relationship between layers when the NR Type-1 precoder has multiple layers, and

$${i}_{2} ( s = ⌊ k / {N}_{R E}^{S B} ⌋ )$$

denotes an index indicating a co-phase between cross-polarized antennas for each SB. └⋅┘ denotes a floor operator.

$${W}_{{i}_{1 , 1} , {i}_{1 , 2} , {i}_{1 , 3} , {i}_{2} ( s = ⌊ k / {N}_{R E}^{SB} ⌋ )} [ s ]$$

denotes a precoder matrix including discrete Fourier transform (DFT) matrices defined by the PMI, G[k,m] may be referred to as an effective CFR matrix at subcarrier k and OFDM symbol m, and g_{b}[k,m] may be referred to as an effective CFR vector at layer b, OFDM symbol m, and subcarrier k.

According to an embodiment of the disclosure, the MI value may correspond to a sum of SNR values for each modulation order, for each layer, and for each subcarrier index, and thus the MI value may correspond to a parameter or an indicator indicating a data throughput in communication between the transmitting node 420 (e.g., a base station) and the receiving node 410 (e.g., a UE).

In the disclosure, the term “combination” may be replaced by various terms indicating a set of information elements (IEs). For example, the combination may be replaced by a set.

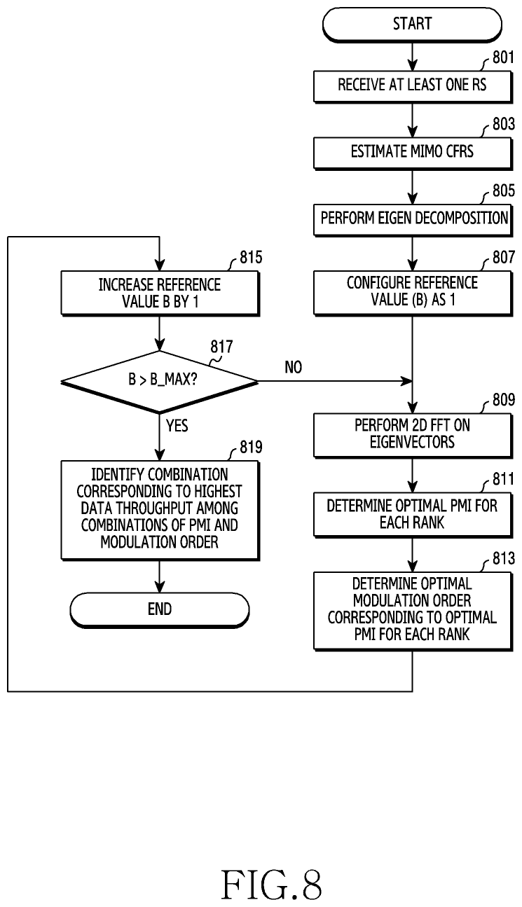

FIG. 8 illustrates a method in which a receiving node identifies, based on received at least one RS, a combination corresponding to the highest MI value among combinations of a PMI and a modulation order according to an embodiment of the disclosure.

Referring to FIG. 8, the receiving node 410 according to an embodiment of the disclosure may receive at least one RS in operation 801.

According to an embodiment of the disclosure, the receiving node 410 may estimate or identify MIMO CFR matrices in operation 803. For example, the receiving node 410 may estimate or identify MIMO CFR matrices based on the received RS.

According to an embodiment of the disclosure, the receiving node 410 may perform eigen decomposition on MIMO CFR matrices in operation 805. For example, the receiving node 410 may convert CFR matrices, by using a PCA technique, into a sum of products of a small number of eigen column vectors and Hermitian vectors of the eigen column vectors, and may identify or obtain at least one vector (or, an eigenvector) by performing eigenvalue decomposition on the converted matrices.

According to an embodiment of the disclosure, the receiving node 410 may configure a reference value B as 1 in operation 807. The reference value B may indicate the number of times the receiving node 410 has determined the optimal PMI in operation 811. For example, when the receiving node 410 identifies a first PMI corresponding to a first rank (e.g., rank 2), a reference value B may be 1. For example, when the receiving node 410 has performed operations 809 to 815, the reference value B may be 2, and the receiving node 410 may identify a second PMI corresponding to a second rank (e.g., rank 3) in operation 811.

According to an embodiment of the disclosure, the receiving node 410 may perform 2D FFT on the eigen matrices in operation 809. For example, the receiving node 410 may perform 2D FFT on the eigen matrices, thereby transforming the elements included in the eigen matrices from the antenna domain indicating antenna characteristics into the angular domain in which the beams are formed.

According to an embodiment of the disclosure, in operation 811, the receiving node 410 may determine a rank-specific optimal PMI, based on the eigen matrices in which 2D FFT has been performed. For example, the receiving node 410 may obtain or determine the optimal PMI corresponding to the first rank (e.g., rank 2) by substituting the 2D FFT-processed eigen matrices (or the values associated with the angles) into Equation 11.

$$( {i}_{1 , 1}^{*} , {i}_{1 , 2}^{*} , {i}_{2}^{*} , {i}_{1 , 3}^{*} ) = arg {max}_{{i}_{1 , 1} , {i}_{1 , 2} , {i}_{2} ( {k}_{1} , {k}_{2} ) = f ( {i}_{1 , 3} )} {ω}_{1} \vert {ζ}_{{i}_{1 , 1} , {i}_{1 , 2}}^{( 0 )} [ 1 ] + {e}^{- j \frac{2 π {i}_{2}}{4}} {ζ}_{{i}_{1 , 1} , {i}_{1 , 2}}^{( 1 )} [ 1 ] \vert + {ω}_{2} \vert {ζ}_{{i}_{1 , 1} + {k}_{1} , {i}_{1 , 2} + {k}_{2}}^{( 0 )} [ 2 ] - {e}^{- j \frac{2 π {i}_{2}}{4}} {ζ}_{{i}_{1 , 1} + {k}_{1} , {i}_{1 , 2} + {k}_{2}}^{( 1 )} [ 2 ] \vert \qquad Equation 11$$

According to an embodiment of the disclosure, the receiving node 410 may determine the optimal modulation order corresponding to the optimal PMI per rank in operation 813. For example, the receiving node 410 may identify a data throughput (or MI value) identified while changing a modulation order (e.g., QPSK, 16QAM), and may determine the modulation order corresponding to a relatively high data throughput as a modulation order (or optimal modulation order) corresponding to the first PMI.

According to an embodiment of the disclosure, the receiving node 410 may increase the reference value B by 1 in operation 815.

According to an embodiment of the disclosure, in operation 817, the receiving node 410 may determine whether a reference value B is greater than a maximum rank B_max. For example, the maximum rank (B_max) may be a value previously configured for the receiving node 410.

According to an embodiment of the disclosure, when the reference value B is greater than the maximum rank, the receiving node 410 may, in operation 819, identify a combination corresponding to the highest data throughput (or MI value) among combinations of PMIs and the modulation orders. For example, the receiving node 410 may identify a first combination corresponding to the highest data throughput between a first combination of a first PMI and a first modulation order, and a second combination of a second PMI and a second modulation order. The receiving node 410 may transmit information on the first PMI and the first modulation order to the transmitting node 420 (e.g., the base station 300).

However, the operation of transmitting information on the first PMI and the first modulation order may be performed only in a case in which the receiving node 410 is the UE 200 and the transmitting node 420 is the base station 300. As another example, when the receiving node 410 is a base station 300 and the transmitting node 420 is a UE 200, the operation of transmitting the information on the first PMI and the first modulation order may be omitted.

According to an embodiment of the disclosure, when the reference value B is smaller than the maximum rank, the receiving node 410 may perform operation 809 again.

Operation 801 of FIG. 8 of the disclosure may correspond to operation 401 of FIG. 4B. The operation of estimating MIMO CFRs in operation 803 of FIG. 8 and the operation of performing eigen decomposition in operation 805 may substantially correspond to operation 403 of FIG. 4B. Operation 809 of FIG. 8 of the disclosure may correspond to operation 405 of FIG. 4B. Operation 813 and operation 817 of FIG. 8 of the disclosure may substantially correspond to operation 701 and operation 703 of FIG. 7. As a result, the embodiment of FIG. 8 may be combined with the embodiments of FIGS. 4B and 7.

However, the correspondence between the above-described operations is merely an example, and the disclosure is not limited to the correspondence described above.

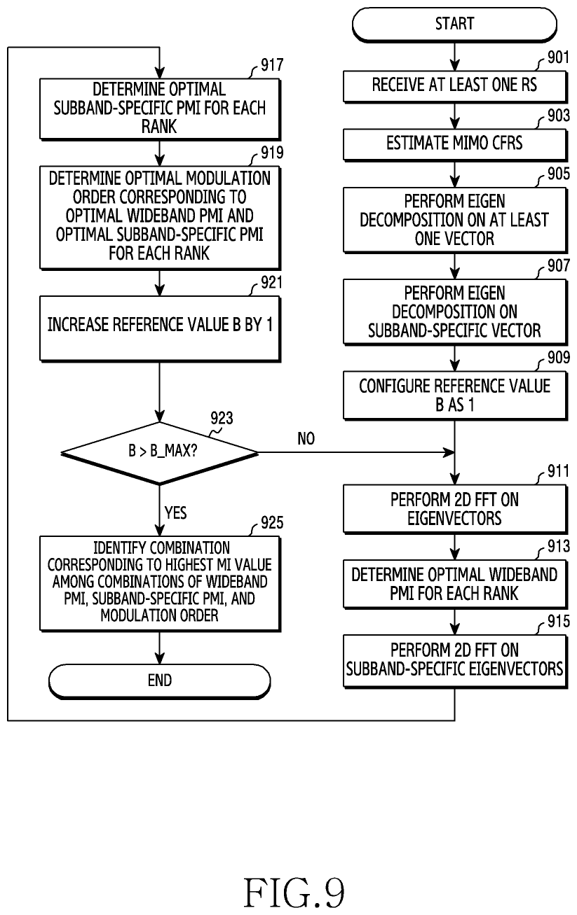

FIG. 9 illustrates a method of identifying a combination corresponding to highest data throughput among combinations of a wideband PMI, a subband-specific PMI, and a modulation order according to an embodiment of the disclosure.

Referring to FIG. 9, the receiving node 410 according to an embodiment of the disclosure may receive at least one RS in operation 901.

According to an embodiment of the disclosure, the receiving node 410 may estimate or identify MIMO CFR matrices in operation 903. For example, the receiving node 410 may estimate or identify MIMO CRF matrices, based on the received RS.

According to an embodiment of the disclosure, the receiving node 410 may perform an eigen decomposition on the MIMO CFR matrices in operation 905. For example, the receiving node 410 may convert CFR matrices by using a PCA technique so that they can be expressed as a sum of products of a small number of eigen column vectors and Hermitian vectors of the eigen column vectors, and may identify or obtain at least one vector (or eigenvector) by performing eigen decomposition on the transformed matrices.

According to an embodiment of the disclosure, the receiving node 410 may obtain a subband-specific matrix through eigen decomposition in operation 907. For example, in a case of a rank of 2, the subband-specific matrix may be expressed as Equation 13-1. The subband-specific matrix may be referred to as a matrix substantially associated with a plurality of antennas included in the receiving node 410 or transmitting node 420 for transmitting downlink data. The index i₂(s) in Equation 13-1 may be a function of SB s.

$$[ \begin{matrix}{ψ}_{s} [ 1 ] & {ψ}_{s} [ 2 ]\end{matrix} ] = [ \begin{matrix}{e}^{j {ζ}_{1}} {v}_{{i}_{1 , 1} , {i}_{1 , 2}} & {e}^{j {ζ}_{2}} {v}_{{i}_{1 , 1} + {k}_{1} , {i}_{1 , 2} + {k}_{2}} \\ {e}^{j {ζ}_{1}} {φ}_{{i}_{2} ( s )} {v}_{{i}_{1 , 1} , {i}_{1 , 2}} & - {e}^{j {ζ}_{2}} {φ}_{{i}_{2} ( s )} {v}_{{i}_{1 , 1} + {k}_{1} , {i}_{1 , 2} + {k}_{2}}\end{matrix} ] + E \qquad Equation 13 - 1$$

According to an embodiment of the disclosure, the receiving node 410 may configure a reference value B as 1 in operation 909. The reference value B may indicate the number of times the receiving node 410 has determined the optimal PMI in operation 811. For example, in a case in which the receiving node 410 identifies a first wideband PMI corresponding to a first rank (e.g., rank 2), the reference value B may be 1. For example, in a case in which the receiving node 410 has performed operations 809 to 815, the reference value B may be 2, and the receiving node 410 may identify a second wideband PMI corresponding to the second rank (e.g., rank 3) in operation 811.

According to an embodiment of the disclosure, the receiving node 410 may perform 2D FFT on a matrix including eigenvectors in operation 911. For example, the receiving node 410 may perform 2D FFT on the matrix including eigenvectors, thereby transforming the elements included in the matrix including eigenvectors from the antenna domain indicating antenna characteristics to the angular domain in which the beams are formed.

According to an embodiment of the disclosure, in operation 913, the receiving node 410 may determine a rank-specific optimal wideband PMI, based on the matrix in which the 2D FFT has been performed. For example, the receiving node 410 may obtain or determine the optimal wideband PMI corresponding to a first rank (e.g., rank 2) by substituting the matrix (or, the values associated with angles) in which 2D FFT has been performed into Equation 11.

$$( {i}_{1 , 1}^{*} , {i}_{1 , 2}^{*} , {i}_{2}^{*} , {i}_{1 , 3}^{*} ) = arg {max}_{{i}_{1 , 1} , {i}_{1 , 2} , {i}_{2} ( {k}_{1} , {k}_{2} ) = f ( {i}_{1 , 3} )} {ω}_{1} \vert {ζ}_{{i}_{1 , 1} , {i}_{1 , 2}}^{( 0 )} [ 1 ] + {e}^{- j \frac{2 π {i}_{2}}{4}} {ζ}_{{i}_{1 , 1} , {i}_{1 , 2}}^{( 1 )} [ 1 ] \vert + {ω}_{2} \vert {ζ}_{{i}_{1 , 1} + {k}_{1} , {i}_{1 , 2} + {k}_{2}}^{( 0 )} [ 2 ] - {e}^{- j \frac{2 π {i}_{2}}{4}} {ζ}_{{i}_{1 , 1} + {k}_{1} , {i}_{1 , 2} + {k}_{2}}^{( 1 )} [ 2 ] \vert \qquad Equation 11$$

According to an embodiment of the disclosure, the receiving node 410 may perform 2D FFT on the subband-specific matrices in operation 915.

According to an embodiment of the disclosure, the receiving node 410 may determine an optimal subband-specific PMI for each rank in operation 917. For example, the receiving node 410 may determine the optimal subband-specific PMI, based on the optimal wideband PMI for each rank.

For example, the receiving node 410 may determine a first subband-specific PMI, based on the first wideband PMI corresponding to the first rank. The receiving node 410 may determine a second subband-specific PMI, based on the second wideband PMI corresponding to the second rank.

According to an embodiment of the disclosure, in operation 919, the receiving node 410 may determine an optimal modulation order corresponding to the optimal wideband PMI and the optimal subband-specific PMI for each rank. For example, the receiving node 410 may identify a data throughput (or MI value) while changing the modulation order (e.g., QPSK, 16QAM), and may determine the modulation order corresponding to a relatively high data throughput as the modulation order (or an optimal modulation order) corresponding to the first wideband PMI and the first subband-specific PMI.

According to an embodiment of the disclosure, the receiving node 410 may increase the reference value B by 1 in operation 921.

According to an embodiment of the disclosure, the receiving node 410 may determine whether a reference value B is greater than a maximum rank B_max in operation 923. For example, the maximum rank (B_max) may be a value preconfigured for the receiving node 410.

According to an embodiment of the disclosure, the receiving node 410 may determine whether the reference value B is greater than the maximum rank B_max in operation 923. For example, the maximum rank (B_max) may be a value preconfigured for the receiving node 410.

According to an embodiment of the disclosure, in case that the reference value B is greater than the maximum rank, the receiving node 410 may identify, in operation 925, a combination corresponding to the highest data throughput (or MI value) among combinations of the first wideband PMI, the first subband-specific PMI, and the modulation order. For example, the receiving node 410 may identify a first combination corresponding to the highest data throughput among a first combination of the first wideband PMI, the first subband-specific PMI, and the first modulation order, and a second combination of the second wideband PMI, the second subband-specific PMI, and the second modulation order. The receiving node 410 may transmit information on the first wideband PMI, the first subband-specific PMI, and the first modulation order to the transmitting node 420 (e.g., the base station 300).

However, the operation of transmitting information on the first PMI and the first modulation order may be performed only when the receiving node 410 is the UE 200 and the transmitting node 420 is the base station 300. As another example, in a case in which the receiving node 410 is the base station 300 and the transmitting node 420 is the UE 200, the operation of transmitting information on the first PMI and the first modulation order may be omitted.

According to an embodiment of the disclosure, when the reference value B is smaller than the maximum rank, the receiving node 410 may re-perform operation 911.

Operations 901, 903, and 905 of FIG. 9 may respectively correspond to operations 801, 803, and 805 of FIG. 8. Operation 909 of FIG. 9 may correspond to operation 807 of FIG. 8. Operation 911 of FIG. 9 may correspond to operation 809 of FIG. 8. Operation 913 of FIG. 9 may correspond to operation 811 of FIG. 8. Operations 921 and 923 of FIG. 9 may correspond to operations 815 and 817 of FIG. 8, respectively.

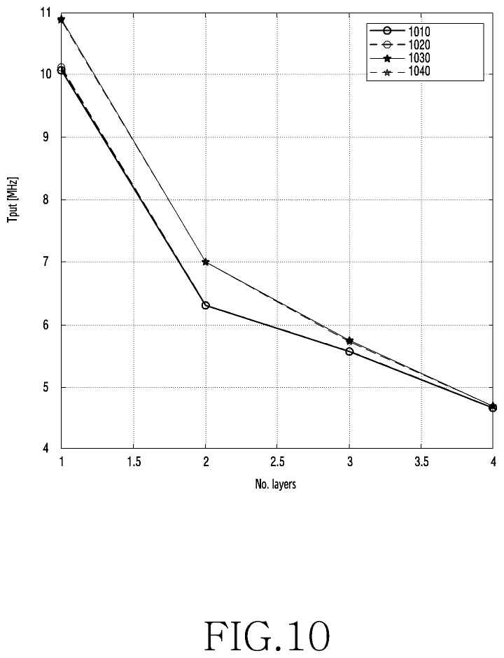

FIG. 10 is a diagram illustrating a comparison of data throughputs between a case in which at least one matrix is converted into values associated with angles of beams and a case in which phases between adjacent entries of an eigen matrix are used instead of performing 2D fast Fourier transform (FFT), according to an embodiment of the disclosure.

Referring to FIG. 10, a first graph 1010 according to an embodiment represents data throughput corresponding to a case in which a wideband PMI is estimated by using phases between adjacent entries of an eigen matrix, instead of performing 2D FFT, under a designated condition. A second graph 1020 represents data throughput corresponding to a case in which a subband-specific PMI is estimated by using phases between adjacent entries of an eigen matrix, instead of performing 2D FFT, under a designated condition.

According to an embodiment of the disclosure, a third graph 1030 represents data throughput corresponding to a case in which at least one matrix is converted into values associated with the angles of the beams to estimate a wideband PMI under a designated condition. A fourth graph 1040 represents data throughput corresponding to a case in which at least one matrix is converted into values associated with the angles of beams and subband-specific PMIs are estimated.

According to an embodiment of the disclosure, the designated condition is a 32×4 MIMO cluster delay line (CDL)-C channel condition in which the transmitting node 420 has 16 horizontal antenna ports and 2 vertical antenna ports, and the receiving node 410 has 4 antenna ports, where the subcarrier spacing (SCS) is 30 kHz, the number of resource blocks (RBs) is 53, all RBs are scheduled, the SNR is-20 dB, and the speed of the UE is 0 km/h.

According to an embodiment of the disclosure, the third graph 1030 and the fourth graph 1040 show data throughputs approximately 7.5% higher than those of the first graph 1010 and the second graph 1020 when the number of layers is one.

According to an embodiment of the disclosure, the receiving node 410 may determine an optimal PMI with relatively higher accuracy by converting at least one matrix into values associated with angles of beams, and as a result, the receiving node 410 may secure a relatively higher data throughput compared to a case in which a PMI is estimated by using phases between adjacent entries of an eigen matrix instead of performing 2D FFT.

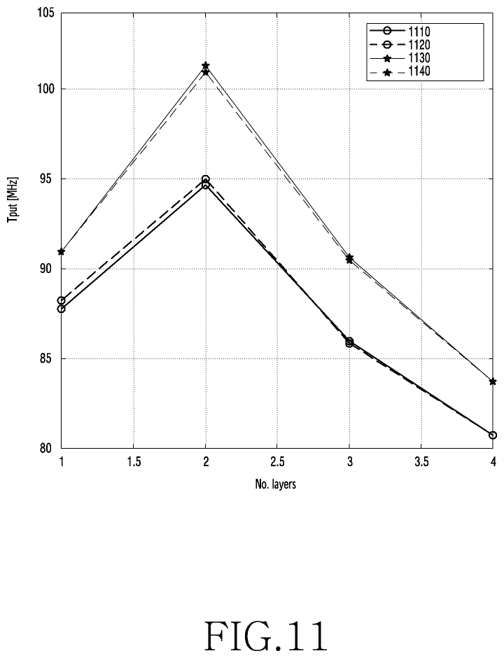

FIG. 11 is a diagram illustrating a comparison of data throughput between a case in which at least one matrix is converted into values associated with angles of beams and a case in which phases between adjacent entries of an eigen matrix are used, instead of performing 2D FFT, according to an embodiment of the disclosure.

Referring to FIG. 11, a first graph 1110 according to an embodiment represents data throughput corresponding to a case in which a wideband PMI is estimated by using phases between adjacent entries of an eigen matrix, instead of performing 2D FFT, under a designated condition. A second graph 1120 represents data throughput corresponding to a case in which a subband-specific PMI is estimated by using phases between adjacent entries of an eigen matrix, instead of performing 2D FFT, under a designated condition.

According to an embodiment of the disclosure, a third graph 1130 represents data throughput corresponding to a case in which at least one matrix is converted into values associated with angles of beams to estimate a wideband PMI under a designated condition. A fourth graph 1140 represents data throughput corresponding to a case in which at least one matrix is converted into values associated with angles of beams to estimate a subband-specific PMI.

According to an embodiment of the disclosure, the designated condition is a 32×4 MIMO cluster delay line (CDL)-C channel condition in which the transmitting node 420 has 16 horizontal antenna ports and 2 vertical antenna ports, and the receiving node 410 has 4 antenna ports, where the subcarrier spacing (SCS) is 30 kHz, the number of resource blocks (RBs) is 53, all RBs are scheduled, the SNR is 0 dB, and the speed of the UE is 0 km/h. For example, unlike the condition of FIG. 10, the SNR is 0 dB under the condition of FIG. 11.

According to an embodiment of the disclosure, the third graph 1130 and the fourth graph 1140 show data throughputs approximately 6.8% higher than those of the first graph 1110 and the second graph 1120 when the number of layers is two.

According to an embodiment of the disclosure, the receiving node 410 may determine an optimal PMI with relatively higher accuracy by converting at least one matrix into values associated with angles of beams, and as a result, the receiving node 410 may secure a relatively higher data throughput compared to a case of using phases between adjacent entries of an eigen matrix instead of performing 2D FFT.

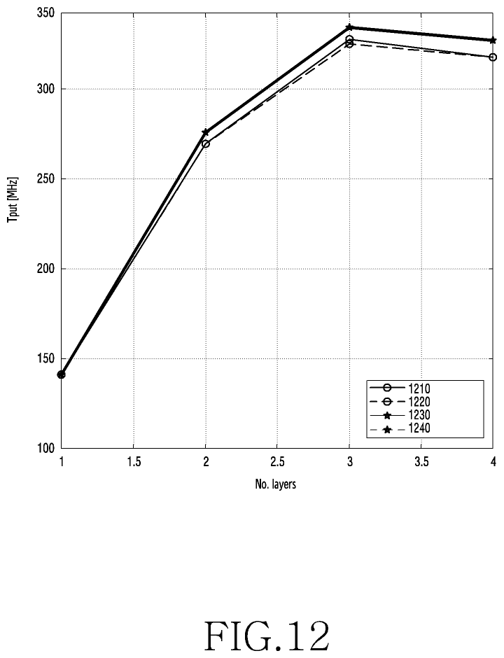

FIG. 12 is a diagram illustrating a comparison of data throughputs between a case in which at least one matrix is converted into values associated with angles of beams and a case in which phases between adjacent entries of an eigen matrix are used instead of performing 2D FFT, according to an embodiment of the disclosure.

Referring to FIG. 12, a first graph 1210 according to an embodiment represents data throughput corresponding to a case in which a wideband PMI is estimated by using phases between adjacent entries of the eigen matrix, instead of performing 2D FFT, under a designated condition. A second graph 1220 represents data throughput corresponding to a case in which a subband-specific PMI is estimated by using phases between adjacent entries of the eigen matrix, instead of performing 2D FFT, under a designated condition.

According to an embodiment of the disclosure, a third graph 1230 represents data throughput corresponding to a case in which at least one matrix is converted into values associated with angles of beams to estimate a wideband PMI under a designated condition. A fourth graph 1240 represents data throughput corresponding to a case in which at least one matrix is converted into values associated with angles of beams to estimate a subband-specific PMI.

According to an embodiment of the disclosure, the designated condition is a 32×4 MIMO cluster delay line (CDL)-C channel condition in which the transmitting node 420 has 16 horizontal antenna ports and 2 vertical antenna ports, and the receiving node 410 has 4 antenna ports, where the subcarrier spacing (SCS) is 30 kHz, the number of resource blocks (RBs) is 53, all RBs are scheduled, the SNR is 20 dB, and the speed of the UE is 0 km/h. For example, unlike the condition of FIG. 10, the SNR is 20 dB under the condition of FIG. 12.

According to an embodiment of the disclosure, the third graph 1230 and the fourth graph 1240 show data throughputs approximately 2.3% higher than those of the first graph 1210 and the second graph 1220 when the number of layers is three.

According to an embodiment of the disclosure, the receiving node 410 may determine an optimal PMI with relatively higher accuracy by converting at least one matrix into values associated with angles of beams, and as a result, the receiving node 410 may secure a relatively higher data throughput compared to a case of using phases between adjacent entries of an eigen matrix instead of performing 2D FFT.

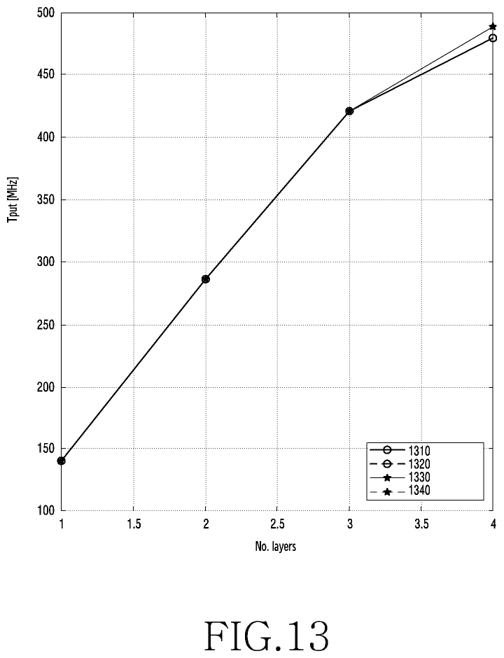

FIG. 13 is a diagram illustrating a comparison of data throughputs between a case in which at least one matrix is converted into values associated with angles of beams and a case in which phases between adjacent entries of an eigen matrix are used instead of performing 2D FFT, according to an embodiment of the disclosure.

Referring to FIG. 13, a first graph 1310 according to an embodiment represents data throughput corresponding to a case in which a wideband PMI is estimated by using phases between adjacent entries of an eigen matrix, instead of performing 2D FFT, under a designated condition. A second graph 1320 represents data throughput corresponding to a case in which a subband-specific PMI is estimated by using phases between adjacent entries of an eigen matrix, instead of performing 2D FFT, under a designated condition.

According to an embodiment of the disclosure, a third graph 1330 represents data throughput corresponding to a case in which at least one matrix is converted into values associated with angles of beams to estimate a wideband PMI under a designated condition. A fourth graph 1340 represents data throughput corresponding to a case in which at least one matrix is converted into values associated with angles of beams to estimate a subband-specific PMI.

According to an embodiment of the disclosure, the designated condition is a 32×4 MIMO cluster delay line (CDL)-C channel condition in which the transmitting node 420 has 16 horizontal antenna ports and 2 vertical antenna ports, and the receiving node 410 has 4 antenna ports, where the subcarrier spacing (SCS) is 30 kHz, the number of resource blocks (RBs) is 53, all RBs are scheduled, the signal to noise ratio (SNR) is 30 dB, and the speed of the UE is 0 km/h. For example, unlike the condition of FIG. 10, the SNR is 30 dB under the condition of FIG. 13.

According to an embodiment of the disclosure, the third graph 1330 and a fourth graph 1340 show data throughputs approximately 0.8% higher than those of the first graph 1310 and the second graph 1320 when the number of layers is four.

According to an embodiment of the disclosure, the receiving node 410 may determine an optimal PMI with relatively higher accuracy by converting at least one matrix into values associated with angles of beams, and as a result, the receiving node 410 may secure a relatively higher data throughput compared to a case of using phases between adjacent entries of an eigen matrix instead of performing 2D FFT.

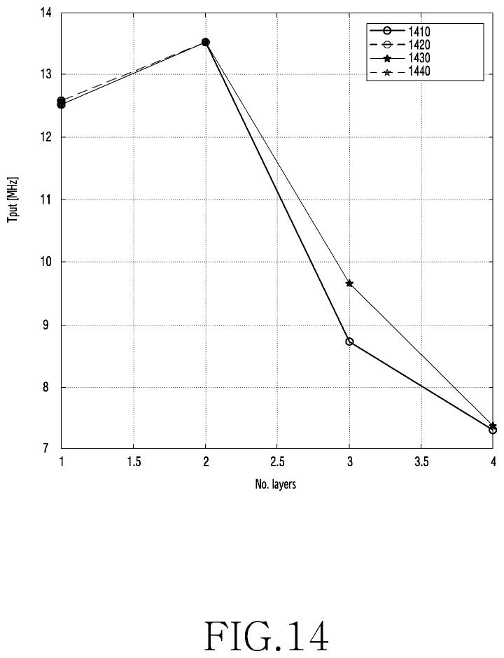

FIG. 14 is a diagram illustrating a comparison of data throughputs between a case in which at least one matrix is converted into values associated with angles of beams and a case in which phases between adjacent entries of an eigen matrix are used instead of performing 2D FFT, according to an embodiment of the disclosure.

Referring to FIG. 14, a first graph 1410 according to an embodiment represents data throughput corresponding to a case in which a wideband PMI is estimated by using phases between adjacent entries of an eigen matrix, instead of performing 2D FFT, under a designated condition. A second graph 1420 represents data throughput corresponding to a case in which a subband-specific PMI is estimated by using phases between adjacent entries of an eigen matrix, instead of performing 2D FFT, under a designated condition.

According to an embodiment of the disclosure, a third graph 1430 represents data throughput corresponding to a case in which at least one matrix is converted into values associated with angles of beams to estimate a wideband PMI under a designated condition. A fourth graph 1440 represents data throughput corresponding to a case in which at least one matrix is converted into values associated with angles of beams to estimate a subband-specific PMI.

According to an embodiment of the disclosure, the designated condition is a 32×4 MIMO cluster delay line (CDL)-E channel condition in which the transmitting node 420 has 16 horizontal antenna ports and 2 vertical antenna ports, and the receiving node 410 has 4 antenna ports, where the subcarrier spacing (SCS) is 30 kHz, the number of resource blocks (RBs) is 53, all RBs are scheduled, the SNR is-20 dB, and the speed of the UE is 0 km/h.

For example, a designated channel condition in FIG. 14 is different from that in FIG. 10 (e.g., CDL-C) in that the channel is CDL-E.

According to an embodiment of the disclosure, the third graph 1430 and the fourth graph 1440 illustrate the same data throughput as the first graph 1410 and the second graph 1420 when the number of layers is two.

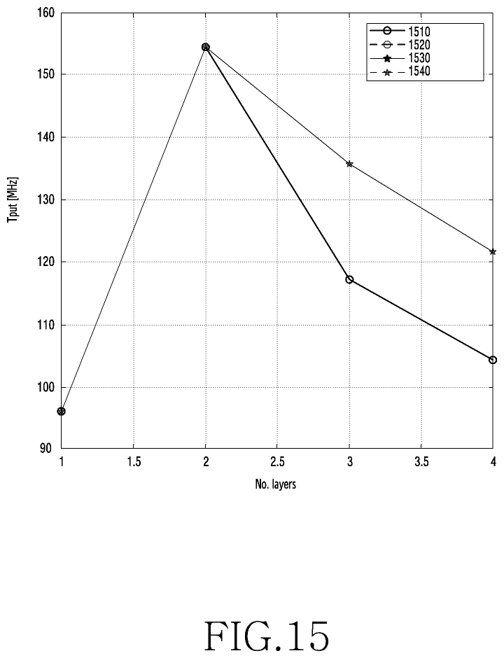

FIG. 15 is a diagram illustrating a comparison of data throughputs between a case in which at least one matrix is converted into values associated with angles of beams and a case in which phases between adjacent entries of an eigen matrix are used instead of performing 2D FFT, according to an embodiment of the disclosure.

Referring to FIG. 15, a first graph 1510 according to an embodiment represents data throughput corresponding to a case where wideband PMI is estimated by using phases between adjacent entries of an eigen matrix, instead of performing 2D FFT, under a designated condition. A second graph 1520 represents data throughput corresponding to a case where a subband-specific PMI is estimated by using phases between adjacent entries of an eigen matrix, instead of performing 2D FFT, under a designated condition.

According to an embodiment of the disclosure, a third graph 1530 represents data throughput corresponding to a case where at least one matrix is converted into values associated with angles of beams to estimate a wideband PMI under a designated condition. A fourth graph 1540 represents data throughput corresponding to a case where at least one matrix is converted into values associated with angles of beams to estimate a subband-specific PMI.

According to an embodiment of the disclosure, the designated condition is a 32×4 MIMO cluster delay line (CDL)-C channel condition in which the transmitting node 420 has 16 horizontal antenna ports and 2 vertical antenna ports, and the receiving node 410 has 4 antenna ports, where the subcarrier spacing (SCS) is 30 kHz, the number of resource blocks (RBs) is 53, all RBs are scheduled, the SNR is 0 dB, and the speed of the UE is 0 km/h. For example, unlike the condition of FIG. 14, the SNR is 0 dB under the condition of FIG. 15.

According to an embodiment of the disclosure, the third graph 1530 and the fourth graph 1540 show a data throughput that is substantially the same as that of the first graph 1510 and the second graph 1520 when the number of layers is two.

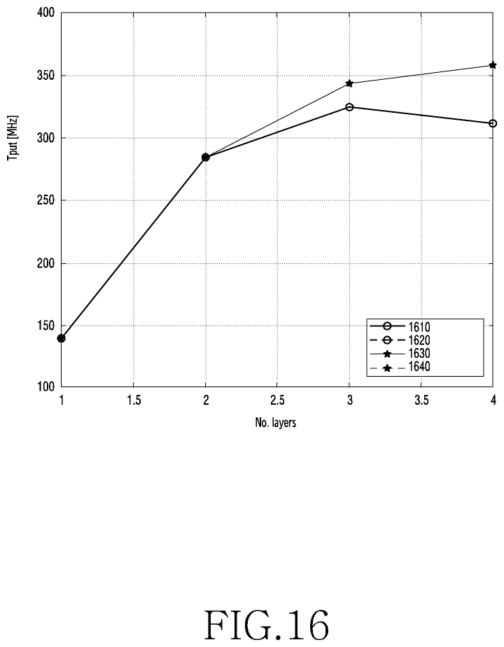

FIG. 16 is a diagram illustrating a comparison of data throughputs between a case in which at least one matrix is converted into values associated with angles of beams and a case in which phases between adjacent entries of an eigen matrix are used, instead of performing 2D FFT, according to an embodiment of the disclosure.

Referring to FIG. 16, a first graph 1610 according to an embodiment represents data throughput corresponding to a case where wideband PMI is estimated by using phases between adjacent entries of an eigen matrix instead of performing 2D FFT under a designated condition. A second graph 1620 represents data throughput corresponding to a case where a subband-specific PMI is estimated by using phases between adjacent entries of an eigen matrix, instead of performing 2D FFT, under a designated condition.

According to an embodiment of the disclosure, a third graph 1630 represents data throughput corresponding to a case where at least one matrix is converted into values associated with angles of beams to estimate a wideband PMI under a designated condition. A fourth graph 1640 represents data throughput corresponding to a case where at least one matrix is converted into values associated with angles of beams to estimate a subband-specific PMI.

According to an embodiment of the disclosure, the designated condition is a 32×4 MIMO cluster delay line (CDL)-C channel condition in which the transmitting node 420 has 16 horizontal antenna ports and 2 vertical antenna ports, and the receiving node 410 has 4 antenna ports, where the subcarrier spacing (SCS) is 30 kHz, the number of resource blocks (RBs) is 53, all RBs are scheduled, the SNR is 20 dB, and the speed of the UE is 0 km/h. For example, unlike the condition of FIG. 14, the SNR is 20 dB under the condition of FIG. 16.

According to an embodiment of the disclosure, the third graph 1630 and the fourth graph 1640 show data throughputs approximately 9.2% higher than those of the first graph 1610 and the second graph 1620 when the number of layers is four.

According to an embodiment of the disclosure, the receiving node 410 may determine an optimal PMI with relatively higher accuracy by converting at least one matrix into values associated with angles of beams. Consequently, the receiving node 410 may secure a relatively higher data throughput compared to a case of using phases between adjacent entries of an eigen matrix instead of performing 2D FFT.

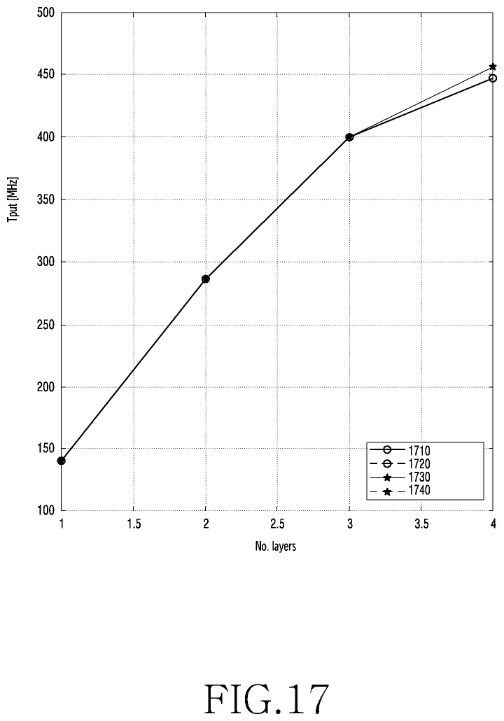

FIG. 17 is a diagram illustrating a comparison of data throughputs between a case in which at least one matrix is converted into values associated with angles of beams and a case in which phases between adjacent entries of an eigen matrix are used instead of performing 2D FFT, according to an embodiment of the disclosure.

Referring to FIG. 17, a first graph 1710 according to an embodiment represents data throughput corresponding to a case where wideband PMI is estimated by using phases between adjacent entries of an eigen matrix instead of performing 2D FFT under a designated condition. A second graph 1720 represents data throughput corresponding to a case where a subband-specific PMI is estimated by using phases between adjacent entries of an eigen matrix, instead of performing 2D FFT, under a designated condition.

According to an embodiment of the disclosure, a third graph 1730 represents data throughput corresponding to a case where at least one matrix is converted into values associated with angles of beams to estimate a wideband PMI under a designated condition. A fourth graph 1740 represents data throughput corresponding to a case where at least one matrix is converted into values associated with angles of beams to estimate a subband-specific PMI.

According to an embodiment of the disclosure, the designated condition is a 32×4 MIMO cluster delay line (CDL)-C channel condition in which the transmitting node 420 has 16 horizontal antenna ports and 2 vertical antenna ports, and the receiving node 410 has 4 antenna ports, where the subcarrier spacing (SCS) is 30 kHz, the number of resource blocks (RBs) is 53, all RBs are scheduled, the SNR is 30 dB, and the speed of the UE is 0 km/h. For example, unlike the condition of FIG. 14, the SNR is 30 dB under the condition of FIG. 17.

According to an embodiment of the disclosure, the third graph 1730 and the fourth graph 1740 show data throughputs approximately 2.8% higher than those of the first graph 1710 and the second graph 1720 when the number of layers is four.

According to an embodiment of the disclosure, the receiving node 410 may determine an optimal PMI with relatively higher accuracy by converting at least one matrix into values associated with angles of beams, and as a result, the receiving node 410 may secure a relatively higher data throughput compared to a case of using phases between adjacent entries of an eigen matrix instead of performing 2D FFT.

A method performed by a receiving node in a wireless communication system according to an embodiment of the disclosure may include receiving at least one reference signal (RS) from a transmitting node, identifying, based on a channel frequency response (CFR) identified based on the at least one received RS, at least one matrix associated with a plurality of antennas included in the receiving node or the transmitting node for transmitting downlink data, converting the identified at least one matrix into values associated with angles of beams formed by the plurality of antennas of the receiving node, determining, based on the values associated with the angles of the beams, at least one precoding matrix indicator (PMI) applicable to the plurality of antennas, and identifying, from the at least one PMI, a first PMI corresponding to a maximum downlink data throughput. Each of the at least one PMI corresponds to at least one rank configured for multiple-input and multiple-output (MIMO).

According to an embodiment of the disclosure, the at least one matrix associated with the plurality of antennas for transmitting the downlink data may be obtained by performing an eigen decomposition on at least one matrix associated with the CFR.

According to an embodiment of the disclosure, the operation of converting the identified at least one matrix to the values associated with the angles of the beams formed by the plurality of antennas for transmitting the downlink data may include performing two-dimensional fast Fourier transform (2D FFT) on respective elements included in the at least one matrix to obtain the values associated with the angles.

According to an embodiment of the disclosure, the at least one matrix may have a number of columns corresponding to the at least one rank configured for the multiple input and multiple output (MIMO).

According to an embodiment of the disclosure, the operation of determining the at least one PMI applicable to the plurality of antennas may include determining the first PMI corresponding to a first rank, based on first values associated with the angles of the beams, comparing the first rank with a maximum rank configured for the receiving node, and in case that the first rank is smaller than the maximum rank configured for the receiving node, determining a second PMI corresponding to a second rank greater than the first rank, based on second values associated with the angles of the beams. The method may further include, in case that the second rank is smaller than or equal to the maximum rank and a first throughput corresponding to the first PMI is greater than a second throughput corresponding to the second PMI, an operation of determining the first PMI as a PMI to be transmitted to the transmitting node.

According to an embodiment of the disclosure, the operation of determining the first PMI corresponding to the first rank, based on the first values associated with the angles of the beams may include obtaining first layer values among the first values associated with the angles of the beams that are obtained by performing two-dimensional fast Fourier transform (2D FFT) on elements corresponding to a first column among elements included in the at least one matrix, obtaining second layer values among the second values associated with the angles of the beams that are obtained by performing the 2D FFT on elements corresponding to a second column among elements included in the at least one matrix, and determining the first PMI corresponding to the first rank, based on the first layer values and the second layer values.

According to an embodiment of the disclosure, the at least one RS may correspond to a channel status information reference signal (CSI-RS) or a sounding reference signal (SRS).

According to an embodiment of the disclosure, the plurality of antennas for transmitting the downlink data may correspond to a plurality of antennas included in a base station.

According to an embodiment of the disclosure, the method may further include identifying a modulation order for each of the at least one PMI corresponding to the at least one rank, identifying a combination of the first PMI and a first modulation order corresponding to a highest mutual information (MI) value among combinations of the at least one PMI and the modulation orders, and transmitting, to the transmitting node corresponding to a base station, information on the combination of the first PMI and the first modulation order. The MI value may indicate a data throughput in communication between the transmitting node corresponding to the base station and the receiving node corresponding to a terminal.

According to an embodiment of the disclosure, the MI value may be determined based on at least one of a modulation order used for communication between the transmitting node and the receiving node, the at least one rank, a subcarrier index, or a symbol index within a slot.

According to an embodiment of the disclosure, the method may further include receiving, from the transmitting node corresponding to a base station, configuration information associated with PMI reporting, determining, based on the configuration information, whether the receiving node is configured to report only a wideband (WB) PMI, and in case that the receiving node corresponding to a terminal is configured to report both the wideband PMI and subband-specific PMIs, the method may further include determining the subband-specific PMIs based on the first PMI, and transmitting, to the transmitting node, information on the subband-specific PMIs.

According to an embodiment of the disclosure, information on the first PMI may include information on an angle of at least one horizontal beam associated with the plurality of antennas, information on an angle of at least one vertical beam associated with the plurality of antennas, and/or information on a phase associated with the plurality of antennas.

According to an embodiment of the disclosure, information on the first PMI may indicate a channel state of a downlink between the transmitting node and the receiving node.

According to an embodiment of the disclosure, the method may further include transmitting, to the transmitting node, a message requesting transmission of the at least one RS.

A receiving node in a wireless communication system according to an embodiment of the disclosure may include a transceiver, and a controller coupled with the transceiver. The controller may be configured to receive at least one reference signal (RS) from a transmitting node, identify, based on a channel frequency response (CFR) identified based on the at least one received RS, at least one matrix associated with a plurality of antennas included in the receiving node or the transmitting node for transmitting downlink data, convert the identified at least one matrix into values associated with angles of beams formed by the plurality of antennas for transmitting the downlink data, determine, based on the values associated with the angles of the beams, at least one precoding matrix indicator (PMI) applicable to the plurality of antennas, and identify, from the at least one PMI, a first PMI corresponding to a maximum downlink data throughput. Each of the at least one PMI may correspond to at least one rank configured for multiple-input and multiple-output (MIMO).

According to an embodiment of the disclosure, the at least one matrix associated with the plurality of antennas for transmitting the downlink data may be obtained by performing eigen decomposition on the at least one matrix associated with the CFR.

According to an embodiment of the disclosure, the controller may be configured to perform two-dimensional fast Fourier transform (2D FFT) on each of the elements included in the at least one matrix to obtain the values associated with the angle.

According to an embodiment of the disclosure, the at least one matrix may have a number of columns corresponding to the at least one rank configured for the multiple input and multiple output (MIMO).

According to an embodiment of the disclosure, the controller may be configured to determine a first PMI corresponding to a first rank, based on first values associated with the angles of the beams, compare the first rank with a maximum rank configured for the receiving node, determine, in case that the first rank is smaller than the maximum rank configured for the receiving node, a second PMI corresponding to a second rank greater than the first rank, based on second values associated with the angles of the beams, and determine the first PMI as a PMI to be transmitted to the transmitting node in case that the second rank is smaller than or equal to the configured maximum rank and a first throughput corresponding to the first PMI is greater than a second throughput corresponding to the second PMI.

According to an embodiment of the disclosure, the controller may be configured to obtain first layer values among the first values associated with the angles of the beams, the first values being obtained by performing two-dimension (2D) fast Fourier transform (FFT) on elements corresponding to a first column among elements included in the at least one matrix, obtain second layer values among the first values associated with the angles of the beams, the first values being obtained by performing the 2D FFT on elements corresponding to a second column among elements included in the at least one matrix, and determine the first PMI corresponding to the first rank, based on the first layer values and the second layer values.

In the disclosure, functions or operations performed by an electronic device may be performed by one or more processors executing one or more instructions stored in the memory. The functions or operations of the electronic device mentioned in the disclosure may be performed by a single processor executing one or more instructions, or by a combination of a plurality of processors executing one or more instructions. The processor mentioned in the disclosure may be understood as including a circuit for performing operations or controlling other elements of the electronic device. For example, the one or more processors may include a central processing unit (CPU), a micro-processor unit (MPU), an application processor (AP), a communication processor (CP), a neural processing unit (NPU), a system on chip (SoC), or an integrated circuit (IC), which are configured to execute one or more instructions. The one or more processors may be configured to perform the operations of the electronic device described above.

As used herein, programs (software modules or software) may be stored in non-volatile memories including random access memory and flash memory, read only memory (ROM), electrically erasable programmable read only memory (EEPROM), magnetic disc storage device, compact disc-ROM (CD-ROM), digital versatile discs (DVDs), or other type optical storage devices, or magnetic cassette. Alternatively, any combination of some or all of them may form memory in which the program is stored. The memory may include a single storage medium or a combination of multiple storage media. The above one or more instructions may be stored in a single storage medium or distributedly stored in multiple storage media.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a receiving node in a wireless communication system, the method comprising:
receiving at least one reference signal (RS) from a transmitting node;
identifying at least one matrix associated with a plurality of antennas, included in the receiving node or the transmitting node, for transmitting downlink data based on a channel frequency response (CFR), wherein the CFR is identified based on the received at least one RS;
converting the identified at least one matrix into values associated with angles of beams formed by the plurality of antennas for transmitting the downlink data;
determining at least one precoding matrix indicator (PMI) applicable to the plurality of antennas, based on the values associated with the angles of the beams; and
identifying, from the at least one PMI, a first PMI corresponding to a maximum downlink data throughput,
wherein each of the at least one PMI corresponds to at least one rank configured for multiple-input and multiple-output (MIMO).

2. The method of claim 1, wherein the at least one matrix associated with the plurality of antennas for transmitting the downlink data is obtained by performing an eigen decomposition on at least one matrix associated with the CFR.

3. The method of claim 1, wherein the converting of the identified at least one matrix into the values associated with the angles of the beams formed by the plurality of antennas for transmitting the downlink data comprises performing two-dimensional fast Fourier transform (2D FFT) on respective elements included in the at least one matrix to obtain the values associated with the angles.

4. The method of claim 1, wherein the at least one matrix has a number of columns corresponding to the at least one rank configured for the MIMO.

5. The method of claim 3,
wherein the determining of the at least one PMI applicable to the plurality of antennas comprises:
determining the first PMI corresponding to a first rank, based on first values associated with the angles of the beams,
comparing the first rank with a maximum rank configured for the receiving node, and
in case that the first rank is smaller than the maximum rank configured for the receiving node, determining a second PMI corresponding to a second rank greater than the first rank, based on second values associated with the angles of the beams, and
wherein the method further comprises, in case that the second rank is smaller than or equal to the maximum rank and a first throughput corresponding to the first PMI is greater than a second throughput corresponding to the second PMI, determining the first PMI as a PMI to be transmitted to the transmitting node.

6. The method of claim 5, wherein the determining of the first PMI corresponding to the first rank, based on the first values associated with the angles of the beams, comprises:
obtaining first layer values among the first values associated with the angles of the beams, the first values being obtained by performing two-dimensional fast Fourier transform (2D FFT) on elements corresponding to a first column among elements included in the at least one matrix;
obtaining second layer values among the first values associated with the angles of the beams, the first values being obtained by performing the 2D FFT on elements corresponding to a second column among elements included in the at least one matrix; and
determining the first PMI corresponding to the first rank, based on the first layer values and the second layer values.

7. The method of claim 1, wherein the at least one RS corresponds to a channel status information reference signal (CSI-RS) or a sounding reference signal (SRS).

8. The method of claim 1, wherein the plurality of antennas for transmitting the downlink data correspond to a plurality of antennas included in a base station.

9. The method of claim 1, further comprising:
identifying a modulation order for each of the at least one PMI corresponding to the at least one rank;
identifying a combination of the first PMI and a first modulation order corresponding to a highest mutual information (MI) value among combinations of the at least one PMI and the modulation orders; and
transmitting, to the transmitting node corresponding to a base station, information on the combination of the first PMI and the first modulation order,
wherein the MI value indicates a data throughput between the transmitting node corresponding to the base station and the receiving node corresponding to a terminal.

10. The method of claim 9, wherein the MI value is determined based on at least one of a modulation order used in communication between the transmitting node and the receiving node, the at least one rank, a subcarrier index, or a symbol index within a slot.

11. The method of claim 1, further comprising:
receiving, from the transmitting node corresponding to a base station, configuration information associated with PMI reporting;
determining, based on the configuration information, whether the receiving node is configured to report only a wideband (WB) PMI;
in case that the receiving node corresponding to a terminal is configured to report both the wideband PMI and subband-specific PMIs, determining the subband-specific PMIs, based on the first PMI; and
transmitting, to the transmitting node, information on the subband-specific PMIs.

12. The method of claim 1, wherein information on the first PMI comprises information on an angle of at least one horizontal beam associated with the plurality of antennas, information on an angle of at least one vertical beam associated with the plurality of antennas, and/or information on phases associated with the plurality of antennas.

13. The method of claim 1, wherein information on the first PMI indicates a channel state of a downlink between the transmitting node and the receiving node.

14. The method of claim 1, further comprising:
transmitting, to the transmitting node, a message requesting transmission of the at least one RS.

15. A receiving node in a wireless communication system, the receiving node comprising:
memory, comprising one or more storage media, storing instructions;
a transceiver; and
at least one processor, comprising processing circuitry, communicatively coupled to the memory and the transceiver,
wherein the instructions, when executed by the at least one processor individually or collectively, cause the receiving node to:
receive at least one reference signal (RS) from a transmitting node,
identify at least one matrix associated with a plurality of antennas, included in the receiving node or the transmitting node, for transmitting downlink data based on a channel frequency response (CFR), wherein the CFR is identified based on the at least one received RS,
convert the identified at least one matrix into values associated with angles of beams formed by the plurality of antennas for transmitting the downlink data,
determine at least one precoding matrix indicator (PMI) applicable to the plurality of antennas, based on the values associated with the angles of the beams, and
identify, from the at least one PMI, a first PMI corresponding to a maximum downlink data throughput, and
wherein each of the at least one PMI corresponds to at least one rank configured for multiple-input and multiple-output (MIMO).

16. The receiving node of claim 15, wherein the at least one matrix associated with the plurality of antennas for transmitting the downlink data is obtained by performing an eigen decomposition on at least one matrix associated with the CFR.

17. The receiving node of claim 15, wherein the at least one matrix has a number of columns corresponding to the at least one rank configured for the MIMO.

18. The receiving node of claim 15, wherein the at least one RS corresponds to a channel status information reference signal (CSI-RS) or a sounding reference signal (SRS).

19. The receiving node of claim 15, wherein the plurality of antennas for transmitting the downlink data correspond to a plurality of antennas included in a base station.

20. One or more non-transitory computer-readable storage media storing one or more computer programs including computer-executable instruction that, when executed by one or more processors of a receiving node in a wireless communication system individually or collectively, cause the receiving node to perform operations, the operations comprising:
receiving at least one reference signal (RS) from a transmitting node;
identifying at least one matrix associated with a plurality of antennas, included in the receiving node or the transmitting node, for transmitting downlink data based on a channel frequency response (CFR), wherein the CFR is identified based on the received at least one RS;
converting the identified at least one matrix into values associated with angles of beams formed by the plurality of antennas for transmitting the downlink data;
determining at least one precoding matrix indicator (PMI) applicable to the plurality of antennas, based on the values associated with the angles of the beams; and
identifying, from the at least one PMI, a first PMI corresponding to a maximum downlink data throughput,
wherein each of the at least one PMI corresponds to at least one rank configured for multiple-input and multiple-output (MIMO).
